(19) United States
(12) Patent Application Publication
(10) Pub. No.: US 2026/0194939 A1
(43) Pub. Date: Jul. 9, 2026

(54) ENERGY-EFFICIENT EDGE COMPUTING SYSTEM AND ARCHITECTURE-INTERFACING CARRIER MODULE

(71) Applicant: GREEN EDGE COMPUTING CORP., Vancouver (CA)

(72) Inventors: Jeffrey MACMILLAN, Victoria (CA); Peter KORTEKAAS, Dripping Springs, TX (US); Justin NAPIER, Victoria (CA)

(73) Assignee: GREEN EDGE COMPUTING CORP., Vancouver, BC (CA)

(21) Appl. No.: 18/870,624

(22) PCT Filed: May 31, 2023
(86) PCT No.: PCT/CA2023/050744

§ 371 Date: Nov. 29, 2024

Related U.S. Application Data
(60) Provisional application No. 63/347,901, filed on Jun. 1, 2022.

(51) Int. Cl. G06F 1/18; H05K 7/14

(52) U.S. Cl. CPC G06F 1/181; H05K 7/1488

(57) ABSTRACT

Described are various embodiments of an energy-efficient edge computing system, and an architecture-interfacing carrier module which is operable therewith or as a standalone unit. Embodiments of the architecture-interfacing carrier module and the energy-efficient edge computing system generally employ a rugged standard, such as a Virtual Path Cross-Connect (VPX) standard or the like, together with a commercial standard, such as a Computer-on-Module express (COMe) standard or the like.

### CROSS REFERENCE TO RELATED APPLICATIONS

This application is a national stage, filed under 35 U.S.C. § 371, of International Application No. PCT/CA2023/050744, filed on 31 May 2023 at the Canadian Intellectual Property Office, and entitled “ENERGY-EFFICIENT EDGE COMPUTING SYSTEM AND ARCHITECTURE-INTERFACING CARRIER MODULE”, which claims the benefit of priority under 35 U.S.C. § 119 (e) based upon U.S. provisional patent application Ser. No. 63/347,901, filed on Jun. 1, 2022 at the United States Patent & Trade Mark Office, the entire contents of each of which is incorporated herein in its entirety by reference.

### FIELD OF THE DISCLOSURE

The present disclosure relates to computing systems, and, in particular, to an energy-efficient edge computing system, and an architecture-interfacing carrier module which is operable therewith or as a standalone unit.

### BACKGROUND

Edge computing is thought to become a $700 billion dollar industry by the year 2030, driven by technological advances including artificial intelligence, the Internet of Things (IoT), 5G, and the smart data revolution in retail and industry, or industry 4.0. Further, it is estimated that within 5 years, 75% of all data generated on Earth will be at the edge, rather than in the cloud. This is set to create an enormous demand for edge computing architectures and server system hardware.

Typical edge computing systems rely on traditional architecture standards developed for rack-mounted server systems. While a multi-billion-dollar industry has justifiably emerged around this framework, it has a number of deficiencies in the context of edge computing, including fixed and relatively large form factors. This leads to a relatively inefficient use of space, increased power consumption and carbon footprint, and insufficient robustness for the operating conditions experienced at the edge. For example, Adlink™ provides the MECS-7211™ edge server system, advertising the key feature of a 19″ rackmount form factor. While such edge servers may leverage technological advances of the commercial data centre space, including high performance processors, the underlying computational modules, as well as the general architectures employed, are inefficient with respect to space, being limited to the rackmount standard, inefficiently and excessively consume power, and generally comprise components designed for clean, temperature-controlled data centre environments.

While alternative commercial products are available in different form factors, such as the Hewlett Packard Enterprise™ Edgeline EL8000 Converged Edge System, such systems continue to be inefficient with respect to computational power per unit volume as well as draw excessive power for operation. Such systems are also exorbitantly costly, in part due to inefficient conversion of commercial computer modules designed for rack-mounted clean environments into a system having a form factor and resilience for operating at the edge.

Independently, the defense industry has invested tremendous resources in the identification and development of computational standards for military applications. For example, computational systems on board submarines, airplanes, helicopters, tanks, and the like, are subjected to extreme conditions of vibration, shock, and temperature, and must concurrently be of a compact form factor so to fit in confined and extreme environments. Some exemplary standards developed and/or adopted by the defense industry include Virtual Path Cross-Connect (VPX) and the Sensor Open Systems Architecture (SOSA) which builds upon VPX and other precursor military compute standards. Such systems may be configured to network mezzanine modules with limited and specialised function.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for an energy-efficient edge computing system, and architecture-interfacing carrier module therefor, that overcome some of the drawbacks of known techniques, or at least, provides a useful alternative thereto. Some aspects of this disclosure provide examples of such systems and methods.

In accordance with one aspect, there is provided a computing carrier module, comprising a ruggedised body comprising circuitry electrically coupling an internal interface and an external interface; the external interface configured to electrically interface with an external computing architecture at least partly compliant with a rugged computational standard corresponding at least in part to a designated form factor and electrical component characteristics; the internal interface configured to structurally and electrically interface with a commercial grade embedded computing module; and a commercial grade embedded computing module interfacing with the internal interface and characterised by a form factor at least partly compliant with a commercial computational standard distinct from, and less rugged than, the rugged computational standard.

In one embodiment, the commercial computational standard comprises a Computer-on-Module express (COMe) standard and wherein the rugged computational standard comprises a Virtual Path Cross-Connect (VPX) standard.

In one embodiment, the computing module is operable as a standalone unit. In one embodiment, the standalone unit comprises a server, a graphics processing unit (GPU) or a switch.

In one embodiment, the ruggedised body defines on a front end a power delivery connector for receiving external power to the computing carrier module. In one embodiment, the power delivery connector comprises a USB-C port.

In one embodiment, the computing carrier module further comprises a remote monitoring controller. In one embodiment, the remote monitoring controller comprises a baseboard management controller (BMC).

In one embodiment, the external interface is hot pluggable with the external computing architecture.

In one embodiment, an external surface of the computing carrier module is configured to thermally interface with a thermal dissipation device. In one embodiment, the thermal dissipation device comprises a tubular structure configured to flow a liquid coolant therethrough to thereby dissipate heat from the computing carrier module in thermal contact therewith.

In one embodiment, the commercial grade embedded computing module comprises one or more of an Intel® Xeon® or an Advanced Micro Devices (AMD) EPYC™ computer processing unit (CPU) module.

In one embodiment, the commercial grade embedded computing module comprises one or more of a Computer-on-Module express (COMe) Type 6 module, a COMe Type 7 module, or a COMe Type 10 module.

In one embodiment, the computing carrier module comprises a volume of approximately 30 cubic inches.

In one embodiment, the rugged computational standard comprises one or more of a VPX standard, a short-VPX standard, an OpenVPX standard, a SpaceVPX standard, a VNX standard, a VITA standard, or a Sensor Open Systems Architecture (SOSA) standard.

In one embodiment, the commercial computational standard comprises one or more of a Computer-on-Module express (COMe) standard, a Qseven standard, a Smart Mobility Architecture (SMARC) standard or a PC104 standard.

In one embodiment, the computing carrier module comprises circuitry configured to manage conflicts between inputs and/or outputs from front-end non-rugged connectors and rear-end rugged connectors.

In accordance with another aspect, there is provided a rugged and compact energy-efficient edge computing system comprising a compact body ruggedised for compliance with a rugged computational standard corresponding at least in part to a designated form factor with associated electrical component and interface characteristics; a chassis securely mounted in the compact body and configured in accordance with the rugged computational standard to securely retain a carrier module removably received therein; and an architecture-interfacing carrier module comprising a ruggedised module body and circuitry electrically coupling respective internal and external interfaces respectively configured to structurally and electrically interface with an external computing architecture comprising the chassis and at least partly compliant with the rugged computational standard, and an embedded computing module characterised by a form factor permitting structural interfacing with the architecture-interfacing carrier module and at least partly compliant with a commercial computational standard distinct from and less rugged than the rugged computational standard.

In one embodiment, the chassis is configured to concurrently securely retain a plurality of the architecture-interfacing carrier modules removably received therein.

In one embodiment, the plurality of architecture-interfacing carrier modules is configured as a multi-server edge computing system.

In one embodiment, the plurality of modules comprises between 2 and 10 architecture-interfacing carrier modules.

In one embodiment, the device body is characterised by a volumetric ratio of between 100 and 150 cubic inches of volume per architecture-interfacing carrier module disposed therein.

In one embodiment, the system is configured to consume one or more of less than approximately 100 W, or between approximately 50 W and approximately 75 W of power per architecture-interfacing carrier module therein during system operation.

In one embodiment, the chassis is configured to retain the plurality of architecture-interfacing carrier modules in accordance with a spatial distribution characterised by an intermodular spacing permitting passive heat dissipation in accordance with a designated operational tolerance.

In one embodiment, the rugged external body integrally comprises the chassis.

In one embodiment, an external surface of the architecture-interfacing carrier module is configured to thermally interface with a thermal dissipation device.

In one embodiment, the thermal dissipation device comprises a tubular structure configured to flow a liquid coolant therethrough to thereby dissipate heat from the architecture-interfacing carrier module in thermal contact therewith.

In one embodiment, the embedded computing module comprises one or more of an Intel® Xeon® or an Advanced Micro Devices (AMD) EPYC™ computer processing unit (CPU) module.

In one embodiment, the system further comprises a backplane circuitry module disposed in the rugged body and electrically interfacing one or more the architecture-interfacing carrier module in accordance with the rugged computational standard.

In one embodiment, the backplane circuitry module is further configured to electrically interface with one or more external digital ports.

In one embodiment, the one or more external digital ports comprise one or more of an ethernet port, a Serial Advanced Technology Attachment (SATA) port, a General-Purpose Input Output (GPIO) port, a fibre optic port, a Universal Serial Bus (USB) port, a power port, a Display port, a Video Graphics Array (VGA) port, a Peripheral Component Interconnect express (PCIe) port, or a mini-PCIe port.

In one embodiment, the rugged body comprises a door.

In one embodiment, the system further comprises a display screen operatively coupled to the architecture-interfacing carrier module and disposed on an inner surface of the door.

In one embodiment, the display screen comprises an electronic ink-based display screen.

In one embodiment, the system further comprises a user input device operatively coupled to the architecture-interfacing carrier module and retractably disposed on an inner surface of the door.

In one embodiment, the user input device comprises one or more of a keyboard, a trackpad, or a mouse.

In one embodiment, the rugged body is configured to provide a sealed internal volume upon closure of the door.

In one embodiment, the system further comprises a digital authentication device operable to unlock the door upon digital verification of an authenticated user.

In one embodiment, the system further comprises an exterior digital camera disposed on an external surface of the rugged device body.

In one embodiment, the system further comprises an interior digital camera disposed on an inner surface of the rugged device body.

In one embodiment, the rugged body comprises a gland plate comprising one or more digital or analog ports for electrically interfacing electrical circuitry within the device body with an external digital device.

In one embodiment, the system further comprises a Computer-on-Module device disposed within the rugged device body and configured to interface the architecture-interfacing carrier module with an external digital device.

In one embodiment, the chassis comprises one or more of a 3U- or 6U-compliant subrack.

In one embodiment, the embedded computing module comprises one or more of a Computer-on-Module express (COMe) Type 6 module, a COMe Type 7 module, or a COMe Type 10 module.

In one embodiment, the architecture-interfacing carrier module comprises volume of approximately 30 cubic inches.

In one embodiment, the commercial computational standard comprises a Computer-on-Module express (COMe) standard and the rugged computational standard comprises a VPX standard.

In one embodiment, the rugged computational standard comprises one or more of a VPX standard, a short-VPX standard, an OpenVPX standard, a SpaceVPX standard, a VNX standard, a VITA standard, or a Sensor Open Systems Architecture (SOSA) standard.

In one embodiment, the commercial computational standard comprises one or more of a Computer-on-Module express (COMe) standard, a Qseven standard, a Smart Mobility Architecture (SMARC) standard or a PC104 standard.

In one embodiment, the architecture-interfacing carrier module is operable as any one of: a server, a graphics processing unit (GPU) or a switch.

In one embodiment, the ruggedised module body defines on a front end a power delivery connector for receiving external power to the architecture-interfacing carrier module. In one embodiment, the power delivery connector comprises a USB-C port.

In one embodiment, the architecture-interfacing carrier module further comprises a remote monitoring controller. In one embodiment, the remote monitoring controller comprises a baseboard management controller (BMC).

In one embodiment, the architecture-interfacing carrier module is hot pluggable with the external computing architecture via the external interface.

In one embodiment, the architecture-interfacing carrier module comprises circuitry configured to manage conflicts between inputs and/or outputs from front-end non-rugged connectors and rear-end rugged connectors.

In one embodiment, the architecture-interfacing carrier module comprises circuitry electrically mapping an electrical interface corresponding to commercial computational standard-compliant embedded computing module to a corresponding electrical interface of the rugged computational standard-compliant external computing architecture.

In one embodiment, the rugged computational standard corresponds to one or more of a defense standard or an aerospace standard.

In one embodiment, the external computing architecture comprises one or more of a digital switch device or a power supply at least partly compliant with the rugged computational standard.

In one embodiment, the chassis is configured to concurrently securely retain a number greater than 10 of the architecture-interfacing carrier modules in accordance with the rugged computational standard.

In one embodiment, the chassis is configured to concurrently securely retain a number greater than 100 of the architecture-interfacing carrier modules in accordance with the rugged computational standard.

In accordance with another aspect, there is provided a digital architecture-interfacing carrier module comprising a ruggedised body comprising circuitry electrically coupling respective internal and external interfaces, wherein the external interface is configured to: electrically interface with an external computing architecture at least partly compliant with a rugged computational standard corresponding at least in part to a designated form factor and electrical component and interface characteristics, and structurally interface with a chassis configured in accordance with the rugged computational standard to securely retain the architecture-interfacing carrier module removably received therein; and wherein the internal interface is configured to structurally and electrically interface with a commercial grade embedded computing module characterised by a form factor permitting structural interfacing with the architecture-interfacing carrier module and at least partly compliant with a commercial computational standard distinct from and less rugged than the rugged computational standard.

In one embodiment, the external interface comprises a digital port configured to concurrently communicate a plurality of distinct electrical signals at least in part to the internal interface.

In one embodiment, the digital port comprises a universal serial bus (USB) type C port.

In one embodiment, the rugged computational standard corresponds to one or more of a defense standard or an aerospace standard.

In one embodiment, the commercial computational standard comprises a Computer-on-Module express (COMe) standard and wherein the rugged computational standard comprises a Virtual Path Cross-Connect (VPX) standard.

In one embodiment, an external surface of the ruggedised body is configured to thermally interface with a thermal dissipation device to dissipate heat from the digital architecture-interfacing carrier module.

In one embodiment, the commercial grade embedded computing module comprises one or more of an Intel® Xeon® or an Advanced Micro Devices (AMD) EPYC™ computer processing unit (CPU) module.

In one embodiment, the commercial grade embedded computing module comprises one or more of a Computer-on-Module express (COMe) Type 6 module, a COMe Type 7 module, or a COMe Type 10 module.

In one embodiment, the digital architecture-interfacing carrier module comprises a volume of approximately 30 cubic inches.

In one embodiment, the rugged computational standard comprises one or more of a VPX standard, a short-VPX standard, an OpenVPX standard, a Space VPX standard, a VNX standard, a VITA standard, or a Sensor Open Systems Architecture (SOSA) standard.

In one embodiment, the commercial computational standard comprises one or more of a Computer-on-Module express (COMe) standard, a Qseven standard, a Smart Mobility Architecture (SMARC) standard or a PC104 standard.

In one embodiment, the digital architecture-interfacing carrier module is operable as any one of: a server, a graphics processing unit (GPU) or a switch.

In one embodiment, the ruggedised body defines on a front end a power delivery connector for receiving external power to the digital architecture-interfacing carrier module.

In one embodiment, the digital architecture-interfacing carrier module further comprises a remote monitoring controller.

In one embodiment, the digital architecture-interfacing carrier module is hot pluggable with the external computing architecture via the external interface.

In one embodiment, the digital architecture-interfacing carrier module comprises circuitry configured to manage conflicts between inputs and/or outputs from front-end non-rugged connectors and rear-end rugged connectors.

In accordance with another aspect, there is provided a carrier board at least partly compliant with a Virtual Path Cross-Connect (VPX) standard modified to receive thereon an embedded computing module at least partly compliant with a Computer-on-Module express (COMe) standard.

In one embodiment, the embedded computing module comprises one or more of an Intel® Xeon® or an Advanced Micro Devices (AMD) EPYC™ computer processing unit (CPU) module. In one embodiment, the VPX standard comprises a 3U VPX.

Features of one or more aspects may be shared with another aspect, and vice versa. Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIGS. 1 and 2 are schematics showing perspective views of an exemplary edge computing system in, respectively, a closed and open configuration, in accordance with one embodiment;

FIGS. 3, 4, 5, and 6 are schematics of, respectively, an exemplary chassis configured to retain a plurality of carrier modules, an exemplary backplane interface configured for use in a rugged computing system, an exemplary carrier module configured for mounting in the exemplary chassis of FIG. 3, and an exploded view the exemplary carrier module of FIG. 5, each configured for use in the exemplary edge computing system of FIGS. 1 and 2 in compliance with a rugged computational standard, in accordance with one embodiment;

FIGS. 7 and 8 are schematics showing, respectively, front and right-side views of the exemplary edge computing device of FIG. 2, in accordance with one non-limiting embodiment;

FIGS. 9 to 12 are schematics of an exemplary network architecture characterising an exemplary edge computing system, in accordance with one embodiment;

FIG. 13 is a schematic of an exemplary network architecture characterising an exemplary edge computing system providing a storage solution, in accordance with one embodiment;

FIGS. 14 to 16 are schematics of respective non-limiting exemplary data redundancy approaches employable in the context of an exemplary edge computing architecture, in accordance with various embodiments;

FIG. 17 is a schematic of another exemplary network architecture characterising an exemplary edge computing system providing a storage solution, in accordance with one embodiment;

FIG. 18 is a schematic of an exemplary network architecture configured for keyboard, video, and mouse (KVM) functionality, in accordance with some embodiments;

FIGS. 19 to 21 are schematics of respective exemplary architectures and showing exemplary components and connectivity of exemplary commercial embedded computing modules interfaced with exemplary rugged computational architectures, in accordance with various embodiments;

FIG. 22 is a schematic of an exemplary profile associated with an exemplary rugged architecture standard, in accordance with some embodiments;

FIGS. 23 and 24 are, respectively, a schematic and a table illustrating an exemplary pattern mapping between computational architecture components, in accordance with one embodiment;

FIG. 25 is a schematic summarising an exemplary mapping of exemplary profile layers of an exemplary architecture, in accordance with some embodiments;

FIG. 26 is a schematic of showing exemplary use of PCIe lanes for various exemplary applications within an exemplary rugged architecture, in accordance with one embodiment;

FIG. 27 is a schematic of an exemplary system architecture enabling for USB interfacing, in accordance with some embodiments;

FIGS. 28 and 29 are, respectively, an image and a schematic representing and exemplary USB port integration within a compact architecture, in accordance with one embodiment;

FIG. 30 is a schematic of an exemplary network architecture comprising an intelligent platform management controller (IPMC), in accordance with one embodiment; and

FIG. 31 is a schematic of an exemplary power and thermal management configuration within an exemplary network architecture, in accordance with one embodiment.

Elements in the several figures are illustrated for simplicity and clarity and have not necessarily been drawn to scale. For example, the dimensions of some of the elements in the figures may be emphasised relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system, device and/or method disclosed herein. No implementation described below limits any claimed implementation and any claimed implementations may cover processes, apparatuses or systems that differ from those described below. The claimed implementations are not limited to apparatuses, systems or processes having all of the features of any one apparatus, system or process described below or to features common to multiple or all of the apparatuses, systems or processes described below. It is possible that an apparatus, system or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein. Further, certain configuration and/or implementation details which can be readily understood by a person skilled in the art from the figures illustrated have not been described, so as to not duplicate information.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this disclosure belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “comprising” as used herein will be understood to mean that the list following is non-exhaustive and may or may not include any other additional suitable items, for example one or more further feature(s), component(s) and/or element(s) as appropriate.

While elements of edge computing have existed for years, a revolution in data collection, analysis and insight-based action is occurring worldwide. For instance, the hardware and infrastructure aspects of the edge computing space is expected to grow by at least $500 billion over the next 8 years. However, this presents several challenges. At present, there are not enough servers, of any kind, to meet this massive increase in demand. It is estimated that within 5 years, 75% of all data generated on Earth will be at the edge, rather than in the cloud or in data centres, giving way to a tremendous need for computational edge architectures for acquiring, storing, and analysing enormous amounts of data in new and challenging environments.

The needs of edge computing are very different than the needs of cloud and data centre computing. Cloud computing uses specialised, high-powered, rack-mounted servers operating in pristine environments where air quality, temperature and power cleanliness are monitored and guaranteed through multiple layers of redundancy. While data centres may create a degree of power usage efficiencies by aggregating large quantities of servers into a single location, it is also proven that they are quite demanding on the environment in terms of water and power consumption, as well as heat generation. Importantly, given the increased amount of data that will be created and/or managed at the edge, the corresponding power consumed by the edge and the related greenhouse gas emissions will vastly exceed humanity's reduction goals unless new compute technologies emerge that require much less power.

Edge computing is presented with several challenges, including the need for lower-latency on-site data processing and increased cyber-security. Further, while computing technologies have sufficiently improved to enable meaningful data processing in non-data centre locations, the needs of the edge are very different than the cloud/data centre. Edge locations can include factories, mining, hospitals, industrial and infrastructure operations, smart cities, agriculture, oil and gas, mining, and even retail locations such as stores, banks, warehouses, groceries, and gas stations. Such locations are subject to fluctuations of power quality, availability, and pricing, and even environmental calamities such as hurricanes, forest fires, heat waves and floods, all of which appear to be occurring with increasing frequency. Moreover, many locations do not have onsite IT staff to address problems when, for instance, hardware breaks down. Further, edge locations can often have considerable dust or particulate in the air, or be subject to vibrations from machinery or vehicles. Importantly, many edge locations are further relatively insecure as compared to fortified data centres. At least in part due to such factors, there exists a need for an edge computing platform that is more rugged and resilient, uses far less power, generates less heat, requires less maintenance, and is physically protected from environmental calamity or unlawful attack, as compared to existing architectures.

Despite the tremendous need for such a platform, to date, edge computing systems simply lack the computational hardware capable of solving the many challenges noted above. Moreover, many consumers, such as business' retail or warehousing locations, or the like, continue to leverage typical rack-mounted technologies, largely due to a lack of suitable multi-server alternatives. Despite their limitations, including costs, such systems are often all that is available in the multi-server computing market.

However, the useful employ of traditional rack-mountable systems in edge environments is challenged by several technical aspects, in addition to those described above. For instance, any solution to a computation problem employing a traditional rack-mounted server will be constrained to a 19″ rack geometry. While this standardised geometry has produced a surrounding multi-billion-dollar industry, which is understandable from the perspective of data centre geometric standardization, as it introduces certainty, efficiency and competition, this approach is not well suited to the edge and/or all edge applications. Once constrained to a rack mount geometry, many opportunities for scaling down systems and correspondingly reducing spatial and environmental footprints are precluded.

For example, rack-mounted servers adhere to a standard defining a fixed width. Despite providing for systems of various depth and height, this standard results in server motherboards and all their related components following standardised dimension footprints. These result in a number of design elements that are wasteful towards power, materials, space, cooling needs, and/or location/placement opportunities. Analogous to how a gas fills a given volume of space, components of rack mounted server systems comprise components distributed to fill space therewithin, leading to inefficient processing and power-hungry electronics. Disengaging from this geometry, however, is challenging, as the entire commercial computing industry is optimised for the rack mount architecture and form factor, making it difficult and costly to source high-quality and relevant components that can be used in newer, more modern geometries. For example, commercial-grade computer-on-module systems are designed and configured in accordance with designated and fixed form factor standards that are not easily implemented within systems that are not compliant with the rack mount architecture. For example, commercial embedded modules often lack sophisticated networking ability, traditionally requiring interfacing via a motherboard or like means that are again typically designed in accordance with rack mount-based form factors in mind. Indeed, most componentry would need to be entirely redesigned to be adapted to standards deviating from rack mount—an intricate and costly endeavour.

While alternative configurations and form factors have been proposed, they are costly, in part due to the conversion from rack mount systems and associated components, which presents significant research and development challenges. Moreover, such systems continue to be inefficient with respect to computational power per unit volume, thus maintaining a relatively high spatial and environmental footprint, as well as drawing excessive power for operation. For example, the Hewlett Packard Enterprise™ (HPE) Edgeline EL8000 Converted Edge System contains two servers within a system having a total volume of 1,125 cubic inches, a weight of 25 lbs, and a power draw of 1,500 W. By today's data center standards, this edge computing product is justifiably considered small, light and power efficient, but is still highly inefficient when viewed from the lens of the edge and environmental requirements described herein. Accordingly, there remains a need for computing systems having the computing capabilities for modern applications while providing the form factor, size, weight, power, cooling, and/or ruggedization requirements suitable for edge computing applications, while concurrently improving their environmental footprint.

The devices, systems and methods described herein provide, in accordance with different embodiments, different examples addressing such challenges through the provision of an energy-efficient edge computing system, and an architecture-interfacing carrier module therefor. In some aspects, such embodiments recognise the need for alternative server system geometries to those conventionally applied for edge computing. Various embodiments further relate to the employ of a computing architectures at least partly compliant with computational standards corresponding at least in part to small form factors. For example, various embodiments relate to the use of computational technologies used in, for instance, defense and aerospace industries, and are compliant with, in addition to form factor and/or dimensional configuration requirements, various robustness metrics, electrical configurations, networking standards or speeds, or the like. Moreover, various embodiments relate to systems and components therefor that combine technical architectures and form factors associated with rugged computational standards with the advanced embedded computing platforms (e.g., commercial grade modules) from the commercial space, thereby providing systems and devices with properties and capabilities exceeding those of any one architecture applied individually. For example, various embodiments relate to systems and devices operable to perform state-of-the-art computing processes within a computing architecture heretofore incapable of performing such processes, while doing so in environments (e.g., edge environments) for such processes to be performed heretofore. Moreover, various such embodiments comprise more compact form factors and may be produced and operate with less power consumption than existing multi-server computing systems.

Certain devices, systems and methods described herein provide a unique combination of edge computing technologies wherein traditionally defence or aerospace technologies are employed and/or modified (structurally, electrically and/or logically) for commercial applications. Indeed, various embodiments disclosed relate to applying rugged computational standards to commercial edge computing, which is a concept previously considered to be too expensive and/or intricate to achieve. In some embodiments, to achieve such solutions, the inherent limitations of the rugged computational standards for defence or aerospace applications are modified, reconfigured, redesigned and/or adapted as described herein, so as to arrive at devices, systems and methods wherein such rugged computational standards are viable as a computing architecture for commercial computing applications.

In accordance with various embodiments, there is provided a computational platform combining various leading compute standards and technologies into a form factor that has a higher compute density than traditional rack-mounted servers, while consuming less volume (e.g., 80% less volume than traditional rack-mounted servers with comparable computing resources) and being fully ruggedised to meet the rigors of edge computing applications. To achieve such computational density, various embodiments relate to the integration of technologies and standards from the commercial embedded computing industry with advanced rugged computing architectures and standards, and especially with advanced rugged computing standards from the defence and/or aerospace industries.

It will be appreciated that the terms ‘rugged’, ‘ruggedized’ or derivations thereof, as used herein, are to be understood as referring in part to a tolerance, resilience, resistance, strength, and/or like attribute corresponding to one or more of various metrics characterising a robustness or ability. For example, a characterisation of ‘rugged’ may refer to, without limitation, a vibration tolerance, an extent or range of temperatures of operability, a shock resistance, a material hardness, a strength or robustness of an electronic or physical connection or the like. However, as used herein, the term ‘rugged’ may additionally refer to various aspects related to computational performance, component speed or longevity, or the like, which may not necessarily or directly reflect a robustness. For instance, various computational standards define connection types, circuitry or component interfaces, switch speeds, component configurations, input/output configurations, pin assignments, and the like. In some embodiments, a rugged computational standard may comprise one that is sufficiently robust for military or defense-based applications.

Accordingly, while not all aspects of a computational standard may refer to a property conventionally associated with a robustness, a ‘rugged computational standard’ will be understood to refer to one or more of a subset of standards generally characterised or associated with robustness. Non-limiting examples of a rugged computational standard include one or more of a Virtual Path Cross-Connect (VPX) standard, a short-VPX standard, an OpenVPX standard, a SpaceVPX standard, a VNX standard, a VMEbus International Trade Association (VITA) standard or sub-standard thereof, and a Sensor Open Systems Architecture (SOSA) standard. However, it will be appreciated that a robust computational standard may comprise alternative standards, or standards yet to be established or codified or defined that generally correspond at least in part to designated electrical component and interface robustness, networking speeds, and the like, and may generally be associated with compact form factor requirements. Accordingly, while various embodiments described below or in the Figures may refer to a VPX standard, architecture, or component for exemplary purposes, it will be appreciated that similar embodiments relate to the employ of or compliance with one or more other rugged computational standards or architectures, non-limiting examples of which are noted above. It will further be appreciated that a rugged computational standard may additionally or alternatively relate to a subset or particular designated standard within a broader rugged computational standard. For example, various embodiments may relate particularly to a 3U VPX standard, a 6U VPX standard, or the like. Further, it will be appreciated that one or more rugged computational standards or sub-standards may comprise similar and/or compatible aspects, and may generally interrelate. For example, a standard such OpenVPX, short-VPX, VNX, or other like standard employed in various embodiments may be generally considered as a VITA standard, while a SOSA or like standard may relate to one which is, for instance, built or developed from a VITA standard. In accordance with some embodiments, a rugged computational standard to which embodiments or aspects of thereof are compliant may generally relate to military defense and/or aerospace standards, and/or standards suitable for rugged industrial and/or manufacturing applications.

It will further be appreciated that while various embodiments relate to a rugged computational architecture or standard, such systems and/or components thereof are not limited to a capability (e.g. to a maximum or minimum tolerance, speed, function, or the like) defined by the standard, and may exceed or improve upon standard requirements. For example, various embodiments relate to device components and circuitry offering additional or improved functionality above a defined rugged computational standard, while concurrently remaining at least partly compliant with the rugged computational standard. Yet other embodiments may deviate from the true standard, for example where one substandard is not met but the remaining sub-standards are met. For example, whilst VPX is architected as a backplane connected standard, requiring plug-in of a VPX server, switch, GPU and/or other cards into a common backplane, to provide the power to the VPX card as well as various inputs and/or outputs interacting with the VPX card, embodiments disclosed herein are specifically designed so as to operate independently of a VPX backplane, the architecture-interfacing carrier modules (server, GPU, switch or other) having its own power delivery and/or inputs and outputs, amongst other features in various embodiments. Indeed, in some embodiments, the rugged computational standard may be employed as a guideline, without strict adherence thereto.

Similarly, a commercial computational standard will be understood to relate to one or more standardised specifications relating to form factors, component types, configurations, connections, speeds, interfaces, input/outputs, or the like. As referred to herein, a commercial computational standard is one that is generally or partially less rugged than a rugged computational standard, and may be distinct therefrom. For example, a commercial standard may define a form factor specification, component or connection requirements corresponding with less robust tolerances, or may define requirements for which there are no analogous definitions (or distinct definitions) in a rugged computational standard. In some embodiments, a commercial computational standard may conversely define computational processing speeds, connection or switch types, functionality, form factors, or the like that exceed those of a rugged computational standard, although various embodiments are not limited to such aspects. For example, various embodiments relate to the use of one or more embedded computing modules at least partly, sometimes fully, compliant with a computer-on-module standard, such as one or more of a Computer-on-Module express (COMe) standard (also referred to as “ComExpress”), a Computer-on-Module for High Performance Compute (COM-HPC) standard, a Qseven standard, a Smart Mobility Architecture (SMARC) standard, a PC104 standard, or an Advanced Telecommunication Computing Architecture (ATCA) standard. Such standards may, in some embodiments, relate to computer modules with capabilities or functions exceeding those traditionally compliant with rugged computational standards, and may comprise form factors generally smaller or larger than those associated with rugged architectures. As described with respect to rugged computational standards, a commercial computational standard may similarly refer to a subset or particular designated standard within a general class of standard, in accordance with various embodiments. Generally, a commercial standard may be considered as ‘less rugged’ than a rugged computational standard, but may inherently comprise a degree of ruggedness. For example, various embodiments relate to the integration of a commercial computing module generally associated with an ‘industrial’ or commercial standard, which may be integrated within, for instance, a military, defence or aerospace grade standard.

In accordance with various embodiments, a commercial embedded computing module may comprise various aspects and/or components, for instance based on the particular application at hand. For example, an embedded computing module may be selected at least in part based on an on-board processor, such as an Intel® Xeon® or Advanced Micro Devices (AMD) EPYC™ computer processing unit (CPU) module, in consideration of, for instance, a form factor of the module of which they are on board. However, it will be appreciated that other modules at least partially, or fully, compliant with a commercial standard may similarly comprise one or more of an Intel® Core™ and/or Atom® component, and/or an AMD or other like on-board component. Indeed, it is envisaged that the embodiments disclosed are workable with other types of CPUs from both of those vendors, as well as others, such as ARM™. Similarly, it will be appreciated that other sub-products with commercial products, brands, or configurations may be employed, such as other ARM-based devices, graphics processing units (GPUs, e.g., NVIDIA®) and other proprietary compute chipsets, such as Pensando.

The devices, systems and methods herein described provide for an edge computing platform interfacing commercial and rugged computational architectures and/or standards. To this end, various embodiments comprise a modular architecture-interfacing carrier module, also referred to herein as an ‘edge card’, comprising a ruggedised module body and circuitry electrically coupling respective internal and external interfaces respectively configured to interface with respective internal and external computational architectures. As is further described below, an external interface of an edge card may be structurally and electrically configured to interface with an external computing architecture at least partly, or fully, compliant with a rugged computational standard. Accordingly, an edge card may be configured such as that an external interface thereof is characterised by a form factor and/or configuration, as well as one or more electrical connection means, to structurally and electrically interface with an external computational architecture at least partly, or fully, compliant with VPX, short VPX, VNX, SOSA, or like standard.

Conversely, the internal interface of an edge card may be structurally and electrically configured to interface with an internal computing architecture at least partly, or fully, compliant with a commercial computational standard. In accordance with some embodiments, this may relate to interfacing with a commercial embedded computing module compliant with a commercial standard such as a Computer-on-Module express (COMe), a Computer-on-Module for High Performance Compute (COM-HPC), a Qseven, a Smart Mobility Architecture (SMARC), a PC104, an Advanced Telecommunication Computing Architecture (ATCA), or like standard. While it will be appreciated that, generally, one or more of various standards with which a computer module is compliant may be accommodated by the systems described herein, some embodiments relate to the provision of an embedded computing module and corresponding edge card configuration based at least in part on a form factor of the embedded computing module. That is, in some embodiments, an embedded computing module may be selected, in addition to the particular computational requirements or preferences at hand, based on its form factor, so to permit interfacing with or within the edge card.

For instance, and in accordance with various embodiments, for a particular application or server system, an external rugged architecture may require a particular carrier module configuration having a designated form factor, wherein any embedded computing module associated therewith is to be completely encased therein. Accordingly, the embedded computing module, in such an embodiments, must be configured in accordance with a respective form factor permitting encapsulation within the defined dimensions of the carrier module, in consideration of carrier module wall thickness, space required for connecting components, and the like. This aspect may limit or define selection of the particular standard by which the embedded computing module complies, and/or limit the particular embedded computer module model that may be structurally accommodated. This in turn may influence or define the electrical and structural configuration, and/or interface(s) thereof, of the carrier module design, in accordance with various embodiments.

In various embodiments, the devices, systems and methods disclosed herein provide specifically for the integration of VPX or similar rugged computational standard with a COMe computer-on-module or similar standard. Such embodiments therefore leverage the ruggedization and other features of VPX to provide a commercially usable solution, as will become apparent from the present disclosure.

For example, various embodiments relate to the integration of an embedded computing module within a VPX-compliant computing architecture. For a particular application or server system, the VPX architecture may require a designated carrier module form factor (e.g., a 3U-compliant form factor of 6″×4″×1″; or as another e.g., VPX may require a strict form factor of 160 mm×100 mm, with a general selectable height of 0.8″, 1″, 1.2″ or 1.5″), while computational requirements of the application may be adequately addressed by various COMe embedded computing modules. However, of the available COMe modules, the VPX requirements may limit the selection of an embedded computing module to a COMe Type 6 or Type 7 so-called ‘Basic’ module. Accordingly, and in accordance with such an embodiment, an architecture-interfacing carrier module may comprise a ruggedised module body (e.g. 3U VPX-compliant) and circuitry electrically coupling respective internal and external interfaces respectively configured to structurally and electrically interface with a VPX-compliant computing architecture and a Type 6 or Type 7 COMe embedded computing module.

Similarly, various embodiments may relate to the configuration of an edge card (and/or external architecture interfaced therewith) based on the application at hand, wherein computational requirements may influence the embedded computing module and associated commercial standard adopted. For example, while a SMARC- or PC104-compliant embedded computing module may be sufficient for some applications, and may indeed correspond to some embodiments, other applications may benefit from a particular processing chip, such as an Intel® Xeon® processor, which is not currently commercially available on SMARC- or PC104-compliant modules, at least in part due to their inherently smaller size as compared to COMe type 6 or 7. The edge card(s) in such embodiments may thus be configured for an embedded module having an Intel® Xeon® processor and that is at least partly, or fully, compliant with standard suitable for the computational tasks to be performed (e.g. a COMe module).

It will be appreciated, however, that various embodiments provide for the exchange of one or more electrical components and/or commercial embedded computational modules within or associated with an edge card. For example, an edge card may be configured to accommodate an embedded computing module at least partly, or fully, compliant with a designated standard (e.g., COMe). However, should the needs of an edge system change (e.g. increased processing is required due to a camera upgrade, or the like), or the like, the edge card, comprising an interface configured for interfacing a designated commercial computing standard (e.g., COMe), may have an existing module therein replaced with an upgraded module at least partly, or fully, compliant with the same commercial computing standard, thereby providing upgradability and modularity to an edge computing system.

By interfacing rugged and commercial architectures using edge cards, various embodiments provide for leveraging of the advanced networking capabilities of rugged computational standards while ensuring the level of flexibility and modern computational processing and input/output (I/O) demanded by the commercial sector. Moreover, and in accordance with various embodiments, such architecture-interfacing carrier modules or edge cards enable cost reduction (~80%) as compared to conventional VPX carriers, which typically comprise unique and fixed embedded computing modules specifically designed for a particular application (i.e., non-commercial modules).

The systems and methods herein described, in accordance with various embodiments, further provide for numerous advantages over conventional approaches associated with either rugged or commercial computing standards or architectures. For example, embodiments herein described provide for highly dense and compact multi-server, server-class, compute solutions that are accessible to and applicable in commercial edge environments. For instance, embodiments herein described relate to the computational resources and functionality corresponding to a half rack of conventional servers, switches, keyboards, monitors, power supplies, uninterrupted power supplies (UPSs), and the like, into a volume approximately that of a shoebox. This corresponds to a reduction of approximately 90% of volume and thus matter with respect to comparable conventional systems, resulting in a greener footprint and reduced demand for power and cooling. Embodiments also provide for the ability to enable only those modules that are needed at a given time, further reducing environmental demands.

Embodiments further provide for increased ruggedness over conventional systems. For example, some embodiments comprise sealed metal enclosures protecting against environmental hazards (e.g., moisture, heat, dust, radiation), physical and cyber-attacks, vibration, and/or theft. Further, requiring no moving parts, embodiments are less likely to fail or require costly maintenance. Security is also increased over conventional edge systems through the provision of out-of-band access control, fully auditable, remote biometric/video controlling high-strength digital locks, aspects that are not currently available in commercial edge computing devices battling form factor and computing resource concerns arising from rack-based form factor reliance. In some embodiments, such security may be provided by way of an outward-facing camera mounted on an external surface of a system that is accessible to a remote IT administrator, wherein, for instance, user identify confirmed prior to the (remote) granting of access to the system (e.g. for maintenance).

Moreover, various embodiments relate to a modular configuration of an edge computing system, wherein carrier modules may be removed from a system for repair, maintenance, and/or upgrade. Such modularity, in addition to improving and/or simplifying shipping, installation, and/or configuration of system components, may provide for the replacement of modules with spare components, reducing down time should a module malfunction. This aspect further increases the potential for recycling and inventory and space management.

Yet further embodiments relate to standalone carrier modules or edge cards, where such modules are operable independently of the system (specifically, of a backplane and/or other cards), having independent power delivery, independent remote management means, independent inputs/outputs, and/or the like, in various embodiments. This aspect may allow for educational testing or demonstration, or laboratory desktop testing or demonstration, of a carrier module, for example, at far lesser expense than the overall system, notwithstanding that the carrier module may have limited features as compared to the multi-server system. This aspect may also provide a cost-effective standalone server, CPU or the like card, or all together but operated independently in standalone configuration, for purchase/use by individual commercial customers, without limitation.

Further, various embodiments are configured to provide power supply and management. In some embodiments, front-facing power delivery to architecture-interfacing carrier modules may be implemented. Moreover, while many commercial systems consume space and add weight to systems for providing redundancy, various embodiments herein described provide such redundancy without significantly increasing system weight or volume.

By interfacing commercial and rugged computational architectures, various embodiments provide for the reduction of power consumption by over 75% as compared to conventional approaches. As such, various embodiments comprise fully functioning edge computing systems operable to passively dissipate heat generated during operation up to approximately 250 W. In accordance with some embodiments comprising a high number of server modules and generating excess heat, active heat dissipation is provided via a heat dissipation device comprising a tubular structure configured to flow a liquid coolant therethrough to thereby dissipate heat from carrier modules in thermal contact therewith. In other embodiments, other cooling subsystems may be employed, as elsewhere described.

In accordance with some embodiments, an edge computing solution may operate in accordance with an OpenVPX or VPX standard. While such standards typically employ computing modules that may be prohibitively costly for most users or applications, and correspond with limited and/or specialised functionality, various embodiments comprise the interfacing of commercial embedded computing solutions within VPX form factors in a manner that provide similar or greater technical functionality to conventional frameworks while reducing the cost of the VPX compute modules by up to 80%.

These and other aspects and advantages will now be further elucidated with respect to the Figures and following description.

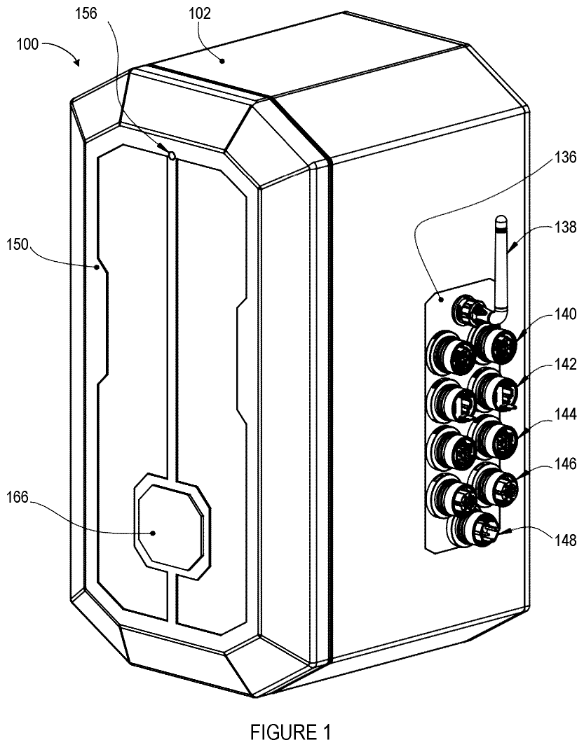

With reference to FIGS. 1 to 8, and in accordance with one exemplary embodiment, a rugged and compact energy-efficient edge computing system, generally referred to using the numeral 100, will now be described. In this embodiment, the system 100 comprises a compact body 102 ruggedised for compliance with a rugged computational standard. The body 100 may comprise, for instance, a metal and/or ceramic material that is resistant to extreme conditions, temperatures, vibrations, and/or forces. In accordance with one embodiment, the body 102 is characterised by a form factor of approximately 15″×8″×8″ (height×width×depth), although it will be appreciated that other configurations and/or form factors may be characteristic of a device body 102, in accordance with other embodiments. For instance, while the system 100 is configured as a multi-server edge computing platform comprising nine server modules on respective carrier cards having a designated module form factor, other embodiments are configured to house more or fewer server modules, and/or server modules of different form factors. Accordingly, a system body 102 may comprise a different form factor depending on, for instance, the particular internal configuration and/or rugged computational standard with which the system 100 is compliant.

Generally, a system body 102 may comprise various other structures, components, interfaces, or the like, such that it is at least partly, or fully, compliant with a rugged computational standard (e.g., VPX). For example, the body 102 may comprise a chassis or like structure for retaining computational modules therein (e.g., a chassis integrally formed of the body 102). Similarly, the body 102 may comprise various circuitry components and/or digital ports, which may be similarly compliant and/or conformal with a rugged computational standard.

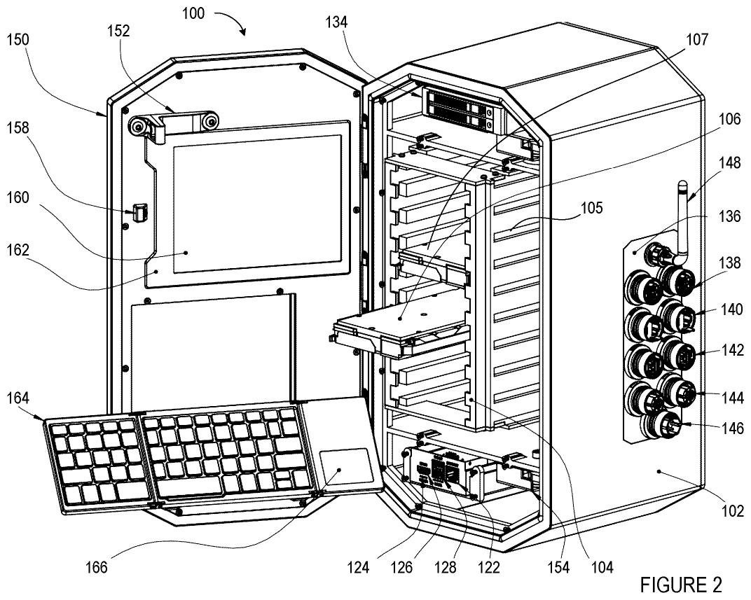

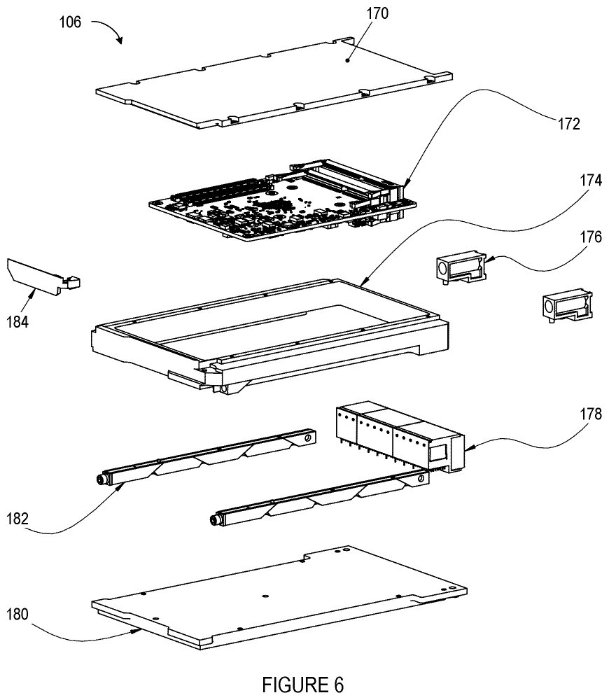

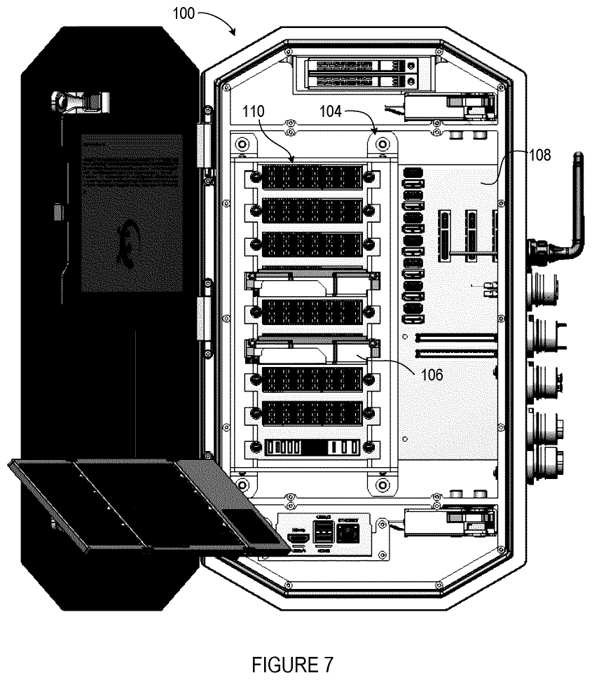

In the exemplary embodiment of FIGS. 1 to 8, the system 100 further comprises a chassis 104 securely mounted in the compact body 102 and configured in accordance with the rugged computational standard (e.g., VPX, OpenVPX, SOSA, or the like) to securely retain an architecture-interfacing carrier module(s) or edge card(s) 106 (see FIG. 6) removably received therein. In accordance with some embodiments, the chassis 104 is configured to concurrently securely retain a plurality of architecture-interfacing carrier modules 106 (e.g., between 2 and 10 modules), although it will be appreciated that other embodiments may be configured to retain a single architecture-interfacing carrier module 106, or greater than 10 architecture-interfacing carrier modules (e.g., 15 to 20 modules). In the FIGS. 2 and 7, while the chassis 104 is configured to retain nine (9) architecture-interfacing carrier modules, the chassis 104 is schematically illustrated for clarity as retaining two architecture-interfacing carrier modules 106 and 107 removably received therein. Such architecture-interfacing carrier modules 106, 107 may be concurrently retained by the chassis 104. However, in some embodiments, such modules may further be interchanged, swapped, replaced, and/or moved to alternate positions on the chassis 104 while maintaining operability of the system 100. For example, while FIG. 2 shows edge card 107 being securely retained by the chassis 104, edge card 106 is schematically illustrated during removal from or introduction to the chassis 104. In accordance with some embodiments, an edge card may be securely retained by the chassis 104, but may further be configured to be removable by a lever. That is, as some embodiments relate to extremely rugged computational standard and applications, retention of an edge card may be effectuated via a mechanism requiring a particularly applied force for removal. Such mechanisms may in turn be at least partly, or fully, compliant with a rugged computational standard, or may be based at least in part on the requirements of the application at hand.

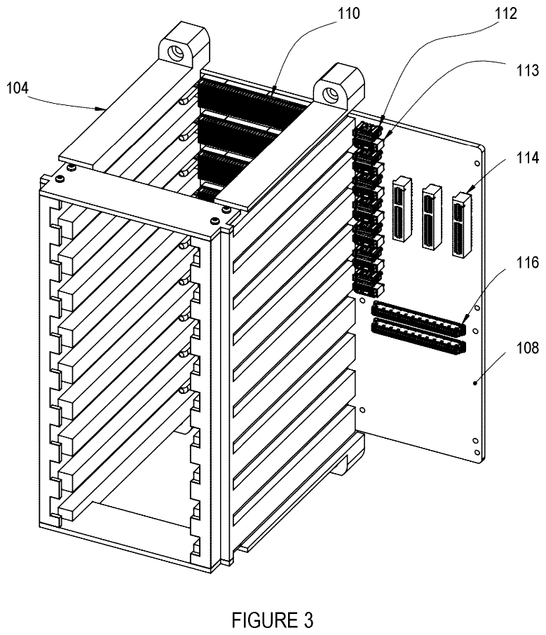

FIG. 3 is a schematic of the exemplary chassis 104 of FIGS. 1 and 2. In this example, the chassis 104 is configured as a VPX-compliant subrack 104, and, in this particular embodiment, more particularly as 3U VPX subrack 104. However, it will be appreciated that other chassis configurations may be similarly employed in accordance with other embodiments. In accordance with some embodiments, a chassis 104 may provide one or more of structural support and heat dissipation. For example, in addition to securely retaining edge card modules 106, 107, a chassis 104 may be thermally conductive to assist in the dissipation of heat from edge cards and/or computational modules therein. For instance, carrier modules 106, 107 may be configured to transfer heat out their sides to metal rails of the chassis 104 and/or body 102 in which they are retained. While such passive dissipation is suitable for some embodiments, it will be appreciated that additional thermal dissipation means may be employed to remove, transfer, and/or dissipate heat from the product envelope (i.e., the system chassis and/or body).

In accordance with some embodiments, the chassis 104 is configured to retain a plurality of architecture-interfacing carrier modules 106, 107 in accordance with a spatial distribution characterised by an intermodular spacing (e.g., as illustrated in FIG. 2) permitting passive heat dissipation (thus conduction-based cooling) in accordance with a designated operational tolerance. In embodiments where a combination of COMe and 3U VPX are employed, to accommodate the COMe commercial embedded computing module within the fixed VPX dimensions of the 3U VPX card chassis, the slots in the cooling rails are made vertically wider to facilitate carrier modules 106, 107 with a wider board edge. That is, the board is not wider than the VPX standard of 100 mm, but the width at its widest point extends upwards and downwards slightly more than in the VPX standard (thus, not in strict compliance with the VPX standard, as same does not fit COMe, yet acceptable for commercial environments). Put differently, in this embodiment where full conduction cooling is employed (e.g., wrapped in metal shell), the board adheres to the VPX-standard rail width, which is one of the most fundamental aspects of VPX's dimensionality, but deviates from the height of the VPX “notch” inside that rail, thereby providing greater height to fit the COMe card. Notably, the foregoing provides at least one example of the reconfiguration and/or redesign undertaken to combine distinct rugged and commercial standards.

For embodiments in which passive heat dissipation is insufficient to regulate system temperatures, for instance in embodiments comprising five or more server modules 106, 107, which the chassis 104 of FIGS. 1 and 2 is configured for, additional thermal dissipation mechanisms may be employed. For example, the chassis 104 is provided with structures 105 to accommodate a thermal dissipation device. In accordance with one non-limiting embodiment, such a thermal dissipation device may comprise a tubular structure configured to flow, for instance, a liquid coolant therethrough to thereby dissipate heat from the architecture-interfacing carrier modules in thermal contact therewith via the thermally conductive chassis 104.

While FIGS. 1 to 3 schematically illustrate the chassis 104 being a distinct component from the system body 102, in accordance with some embodiments, other embodiments relate to a system 100 in which the device body 102 and chassis 104 configured to retain edge card modules 106 comprise a single structure. For example, the chassis 104 may be integrally formed of the body 102, or vice versa. Accordingly, a ‘chassis’ may, in some embodiments, be considered as the general housing in which edge card modules 106, 107 are securely retained and providing for operation thereof, in accordance with a rugged computational standard.

Moreover, while the embodiment of FIGS. 1 to 8 relate to a chassis 104 being configured to retain nine (9) carrier modules 106, 107, embodiments are not limited to such a configurations. For example, some embodiments relate to a chassis 104 being configured to provide any number between 1 and 10 of the illustrated slots for receiving edge card modules 106. For example, another embodiment may comprise 3 chassis slots for receiving three edge card modules 106, 107. Such an embodiment may thus generally be characterised by a smaller overall system form factor, wherein the system body 102 may be similarly scaled down, while maintaining compliance with a rugged computational standard, thus further reducing spatial and environmental footprint.

Conversely, various embodiments relate to systems 100 configured to house large numbers of modules 106, 107 in accordance with a rugged computational standard. For example, a system, including a system body and/or chassis may be configured to concurrently securely retain a number greater than 50 or greater than 100 architecture-interfacing carrier modules 106, 107 in accordance with a rugged computational standard. For example, one embodiment comprises a system configured to retain 100 single-board computers and/or edge cards therein. Such an embodiment may relate to a system of approximately the same overall size as conventional server rack system, but with significantly less depth (i.e., reducing the form factor), with comparable or greater processing power.

In yet other embodiments, groups of carrier modules with related or cooperative functionality may be housed within single chassis and/or bodies, with multiple bodies (or systems) forming an array of system units operable as a modular edge computing system, which is configurable to suit any particular application. The array of system units may be spaced apart and/or arranged in any suitable arrangement for the application, and in various embodiments, may communicate via wired or wireless communication means. In some embodiments, individual system units may be dedicated to certain tasks and/or functionality, such that individual system units are independently operable and/or maintainable, to contribute to the overall functionality of the modular edge computing system.

Returning again to the system 100 of FIGS. 1 to 3 comprising nine chassis slots for receiving modules therein, it will be appreciated that while some of such slots may be designated and configured for housing and/or retaining architecture-interfacing modules comprising commercial modules within the context of a rugged framework and standard, some such slots may additionally or alternatively relate to the housing and/or retention of alternative components or aspects of a computational architecture. For example, one embodiment related to FIGS. 1 to 3 relates to a system configured to retain, in addition to seven architecture-interfacing modules, a rugged computational standard-compliant power supply and a rugged computational standard-compliant network switch. For example, one embodiment relates to two respective slots of the chassis 104 retaining a VPX power supply and a VPX network switch. It will be appreciated that some such embodiments may relate to conventionally configured rugged power supply and/or switch, others may relate to a power supply and/or switch that is specialised and/or configured for a particular system architecture and/or components thereof. Similarly, while some embodiments relate to the retention within architecture-interfacing modules 106 comprising commercial single-board computers (SBCs), GPUs, and/or other payload modules, other customised SBC modules relating to commercial aspects, components, and/or standards with which they are compliant, are similarly herein considered, in accordance with other embodiments.

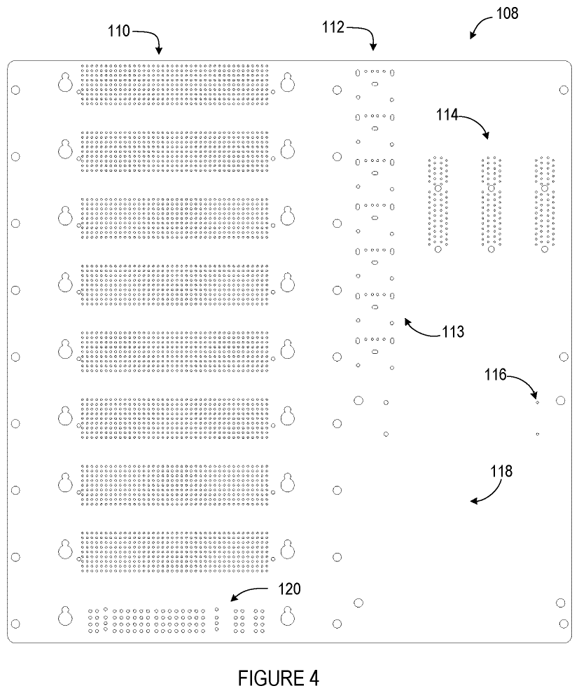

As shown in FIGS. 3 and 4, this embodiment further includes a backplane circuitry module 108, also referred to herein as a ‘backplane’, for electrically coupling various system components and/or providing system interfacing with external devices and/or power sources, in various embodiments. While backplane technologies are known in the art of rugged computational architectures, various embodiments herein described may expand or improve over conventional backplane configurations, for instance to leverage additional functionalities provided by commercial embedded computing modules in communication therewith, via improved edge card configurations and/or interfacing capabilities, and/or backplane configuration for interfacing with devices not conventionally interfaceable with ruggedised platforms.

For example, the exemplary backplane 108 of FIGS. 3 and 4 comprises an array of carrier module interfaces 110. While the exemplary backplane of 108 of FIGS. 3 and 4 is configured in accordance with a 3U VPX standard, it will be appreciated that other configurations at least partly, or fully, compliant with various other rugged computational standards are herein considered. Further, the backplane 108 comprises a USB interface 112, as well as an array of additional (and customisable) connection interfaces. For example, the backplane 108 comprises an array of distinct interface types 113, 114, and 116. Interestingly, due to the extremely efficient use of space provided by the embodiments herein described, the backplane 108 comprises additional area 118 on/in which additional interfaces may be configured for a variety of additional and/or alternative functionality. Further, the backplane 108 further comprises an interface 120 for electrical and operable coupling with a Computer-on-Module device 122 (e.g. a Raspberry Pi or like module) disposed within the rugged device body 102 and configured to interface with the architecture-interfacing carrier module(s) 106, but also with an external digital device via USB ports 120, ethernet ports 128, HDMI ports 126, or other port configurations. Notably, other embodiments may include a similar Computer-on-Module device in a switch or the like.

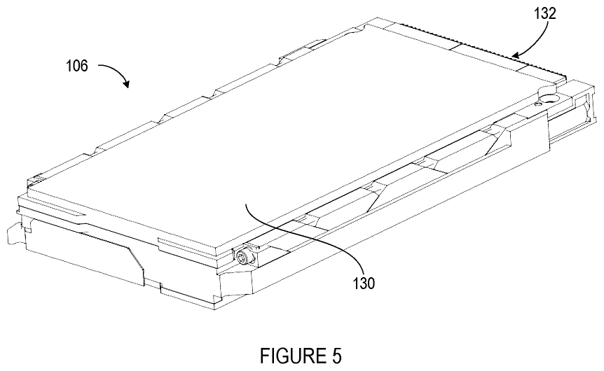

FIG. 5 is a schematic of an exemplary architecture-interfacing carrier module 106 or edge card 106 comprising an exemplary ruggedised module body 130. In this example, the edge card 106 is configured in accordance with a 3U VPX standard, and comprises ruggedised outer surfaces and coupling structures configured to provide retention in a chassis 104 under extreme conditions of vibration and shock. Accordingly, in this example, the edge card 106 is characterised by a form factor of approximately 6″×4″×1″. The edge card 106 further comprises, on the rear surface in FIG. 5, an external electrical coupling interface 132 for interfacing with the external computing architecture (e.g. backplane 108) in accordance with the rugged computational standard (e.g. in this case, VPX). However, it will be appreciated that the edge card 106 may be configured in accordance with another rugged computational standard, and may accordingly comprise various form factors and/or interface configuration compliant therewith, such as a short-VPX standard, VNX standard, or the like.

As described further below, the edge card 106 further comprises circuitry electrically coupling the external electrical interface 132 with an internal interface in turn interfacing with an internal commercial-grade embedded computing module. Accordingly, the commercial embedded computing module, when mounted within an edge card 106 mounted within the rugged architecture (e.g., structurally via the chassis 104 and body 102 and electrically via the backplane 108), is operably interfaced within the rugged architecture in compliance with a rugged computational standard, and may leverage the networking functionality and compact form factors thereof, in accordance with various embodiments. Interestingly, and in accordance with various embodiments, such computational modules integrating commercial processing units within rugged architectures, when optimised to reduce power consumption while maintaining high computing standards, allow a completely functional multi-server computing system (i.e. including all powering, cooling, computation, storage, and the like) to consume between approximately 50 W and approximately 75 W of power per architecture-interfacing carrier module therein used during operation (in other embodiments, up to 110 W, although not limiting). For example, from an analysis of both weight (mass) and volume of embodiments herein described, both the entire system 100 and architecture-interfacing modules 106, as compared to the average commercial rack-mounted equivalent, are measurably much smaller. For instance, the Hewlett Packard® Enterprise (HPE) Edgeline EL8000 contains two full servers within, and has a total volume of 1,125 cubic inches, a weight of 25 lbs, and a power draw of 1,500 W. Comparatively, a system as herein described comprising two modules 106, with complete surrounding architecture to enable full operation, has a volume of 25 cubic inches, a weight of 3 lbs, and a power draw of 120 W. This represents a volume reduction of 98%, power reduction of 92%, and a weight reduction of 88%, in one embodiment.

The exemplary architecture-interfacing module 106 of FIG. 5 is further schematically illustrated as an exploded view of exemplary components thereof in FIG. 6. In this example, the edge card module 106 comprises an upper heat spreader plate 170, which, among other structural aspects, such as providing retainability of the module 106 within a system 100 or chassis 104 in compliance with a rugged computational standard (e.g., 3U VPX), may facilitate the distribution of heat away from internal components, such as a printed circuit board (PCB) and/or other commercial embedded computing modules. The module 106 further comprises a rugged carrier card (e.g., a VPX carrier card) 172, which, as described further below, may interface a commercial embedded computing module (e.g., a COMe or similar module) with a rugged interface (e.g., a VPX interface). The module 106 further comprises a main module body 174, which, in this non-limiting example, corresponds with a 3U VPX card chassis. Allowing selective positioning of the module 106 with respect to (e.g., coupling with) a backplane or comparable rugged architectural component are, in this case, insertion keys 176.

In the exemplary embodiment of FIG. 6, the edge card module 106 further comprises a connector block 178, which, as described further below, may comprise circuitry elements configured to interface an inner commercial embedded computing module with an external rugged architecture (e.g., an inner COMe-compliant module with an external VPX backplane and/or framework).

This exemplary module 106 also comprises a lower heat spreader 180 with similar function to the upper heat spreader 170. This particular exemplary edge card module 106 further comprises wedge locks 182 which, while providing ruggedness to the edge card module 106 and retention thereof within a rugged architecture, may facilitate the conduction of heat from module components to a surrounding environment, such as the chassis 104 (e.g., a VPX subrack). Finally, the exemplary edge card module 106 comprises a latch clip 184, providing for insertion and removal of the edge card module 106 to/from a rugged architecture (e.g., a VPX backplane).

Various embodiments may further relate to an edge computing system 100 comprising various other features and/or advanced functionality. For example, the embodiment of FIGS. 1 and 2 further comprises a storage bay 134 within the rugged body 102, for instance to provide increased memory storage abilities (e.g., to store video or other forms of data). In this example, the storage bay 134 comprising a solid-state drive (SSD) memory.

In accordance with some embodiments, the rugged device body 102 may further comprise a gland plate 136 comprising one or more digital ports for electrically interfacing electrical circuitry within the device body 102 with an external digital device. It will be appreciated that, for some applications, such as those in which security and robustness are of particular concern, a system body 102 may not comprise a gland plate 136, and instead comprise a rugged and continuous enclosure to enhance security. However, the embodiment of FIGS. 1 and 2 comprises a gland plate 136 comprising digital ports for communicating with external device, including, in this example, two each of fibre optic connectors 138, ethernet interfaces 140, USB connectors 142, and general-purpose input/output (GPIO) connectors 144. It will be apricated, however, that such architectures may be configured in accordance with various combinations of inputs, outputs, and/or communication ports. For example, different embodiments may comprise different number and combinations of any one or more of a Serial Advanced Technology Attachment (SATA) port, a General-Purpose Input Output (GPIO) port, a fibre optic port, a universal serial bus (USB) port, or a power port, a Display port, a Video Graphics Array (VGA) port, a Peripheral Component Interconnect Express (PCIe) port, or a mini-PCIe port. Moreover, a gland plate 136 may be configured, in some embodiments, such that it is flush to the edge of the system body 102, as shown in FIGS. 1 and 2, or, in accordance with other embodiments, recessed within the system 100, for instance to provide for additional and/or alternative internal connections. For example, one embodiment relates to this latter configuration, wherein only internal connections are provided, such as via a wire conduit feed.

In the example of FIG. 2, power is provided to the system via a power connection 146 in the gland plate 136, although alternate configurations may be employed for providing power and communications, for instance for highly secure applications. For example, for secure wall-mounted solutions, power and other communication ports may be provided through a connector at the rear of the device, wherein signal is provided directly from a source in the wall to which the system is mounted. It will be appreciated that the gland plate 136 and connection ports thereof may be configurable or customisable, in accordance with various embodiments. For example, in the exemplary embodiment of FIGS. 1 and 2, the gland plate 136 is further configured to accommodate an antenna 148. In accordance with some embodiments, such communication, signal, and/or power ports may be operatively coupled to a backplane 108 networking system components.

The rugged and compact body 102 of the exemplary system 100 of FIGS. 1 and 2 further comprises a door 150. In accordance with some embodiments, the door 150 and remaining body 102 may be configured such that a seal may be provided upon closure of the door 150. In some embodiments, the seal provided may be hermetic. However, various embodiments generally relate to a sealing of the system such that dust, dirt, and/or moisture introduction is minimised or precluded. For example, and without limitation, the system may be configured such that it is at least partly, or fully, compliant with requirements of an IP67 or IP68 certification. Further, the door 150 may be securely locked to prevent unauthorised entry. For example, the door 150 and body 102 of the system 100 comprise two respective lock strikes 152 and corresponding receiving mechanisms 154 operable to provide resistance to extreme forces while being digitally addressable. For example, the locking mechanisms may be digitally activated/deactivated upon digital authentication via a digital authentication device operable to unlock the door 150 upon digital verification of an authenticated user identity or permission. For example, the system 100 further comprises an exterior digital camera 156 disposed on an external surface of the door 150 rugged device body 102. Image or video data acquired by the external camera 156 may be employed to, for instance, perform an authentication process verifying an authorisation status of a user, prior to permitting entry/access, or otherwise prior to triggering an alarm.

Similarly, the system 100 further comprises an interior digital camera 158 disposed on an inner surface of the door 150 of the device body 102. In this case, the interior camera 158 is mounted such that when the door 150 is opened (e.g., for maintenance), the camera 158 is facing the interior of the device body. This may be beneficial to, for instance, provide image or video data to a remote technician to provide technical support to a non-technical and/or on-site user attempting maintenance. Accordingly, it will be appreciated that the system 100 may be further outfitted with an audio communications system, for instance to provide teleconferencing functionality between an on-site and a remote user.

In accordance with various embodiments, an edge computing system 100 may further comprise a display screen 160 operatively coupled to internal computing modules (e.g., architecture-interfacing carrier modules 106, COMe module 122, or the like). In some embodiments, such a display screen 160 may be mounted on an inner surface of the door 150, thereby providing a high degree of security. In one embodiment, the display screen 160 is mounted on an inner surface of the door 150 via a bezel 162. In some embodiments, the display screen 160 comprises an electronic ink (e-ink) display screen, and thereby may produce reduced power requirements of the system 100 as compared to comparable systems comprising power-hungry displays. Such a display 160 may be configured, for instance, to interface with various modules via the backplane 108, and may display various aspects of data related to the system 100, or enable teleconferencing, for instance with a remote technician.

The exemplary system 100 further comprises a user input device 164 operatively coupled to system modules (e.g., the architecture-interfacing carrier modules), allowing a user to interact with the system 100. For example, the system 100 comprises a keyboard 164 having a trackpad 166 providing the functionality of a mouse, but incorporated within a single user input device 164. Such aspects again provide advanced functionality, while minimising spatial footprint, all while providing high standards of security through the placement of components within the rugged enclosure 102. Moreover, and in accordance with various embodiments, such input devices 164 may be configured in a retractable manner, such that they may be configured in a first compact configuration while not in use (e.g., when the door 150 is securely shut, thereby facilitating the reduced size and compactness of the system 100), and reconfigured into a second open configuration (e.g. that of FIG. 2) for use.

In accordance with some embodiments, the device body 102 and/or door 150 thereof may comprise additional materials and/or structures 166. Such features may be ornamental, or, in accordance with other embodiments, provide additional structural support to increase robustness and/or system impenetrability.

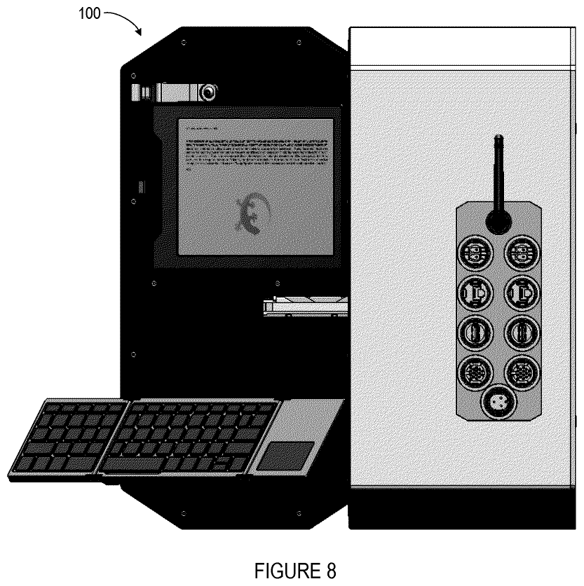

For greater clarity, FIG. 7 is a schematic showing a front view of the system 100 with the door 150 open, showing various configurational aspects related to the chassis 104, backplane 108, and edge card interfaces 110 thereof. FIG. 8 is a schematic showing a right-side view of the system 100 with the door 150 open, showing various components disposed on an inner surface of the door 150. While the embodiments described above with respect to FIGS. 1 to 8 schematically illustrate an open architecture wherein the chassis 104, backplane 108, and like components are visible to a user (e.g. upon opening the door 150, as schematically illustrated in the front view of the system 100 in FIG. 7 for clarify), various embodiments relate to a system 100 in which such aspects are behind, and protected and/or shielded by a panel covering. Such a panel may further increase security and ruggedness, while offering structural support to various modules and/or connections thereto.

In accordance with the foregoing description, one non-limiting embodiment thus relates to a system comprising a wall-mountable rugged device enclosure body approximately 15″×8″×8″ configured to contain up to nine server-class commercial processing units interfaced within a rugged framework through architecture-interfacing carrier modules. For example, one embodiment provides on board a rugged architecture interfacing seven Intel® Xeon® (e.g., 4 to 24 core) and/or AMD Epyc™ CPUs modules, optional GPUs for AI processing, two high-speed switches, power supplies, UPS and batteries, monitor, keyboard, a multitude of I/O connections, and remote management and health monitoring hardware. In such an embodiment, the rugged body may be entirely metallic and hermetically sealed, and thus fully protected against environmental stresses such as moisture, air particulate, vibration, assault, and large temperature variations (e.g., −40 to 85 degrees Celsius). Moreover, such embodiments may further comprise a door openable by an advanced digital authentication system. The authentication system may be configured to be off-network, and configured to be resistant to hacking, and to power one or more digital locks with high protective force (e.g., two locks with 5,800 Newtons of protective force each). Such embodiments may thus be well suited to physically and digitally securing computational resources and data in remote or insecure locations.

While some embodiments relate to systems configured for passive heat dissipation (e.g., conduction-based cooling), some embodiments comprising extensive computing resources (e.g., between 5 and 10 server modules, or embodiments comprising 100 or more modules) may comprise active heat dissipation means, such as liquid cooling. Regardless of compute intensity, various embodiments provide for thermal dissipation without any moving parts, such as a fan. Accordingly, various embodiments may be characterised by a high Mean Time Between Failure (MTBF), reducing user costs and system down time. However, despite requiring little active thermal dissipation, various embodiments may concurrently be provided with environmental protection and further heat dissipation assistance via a ceramic coating (e.g., on the system body 102).

In other embodiments, the active heat dissipation means comprises a heat sink (e.g., fins), a heat exchanger, one or more fans, or the like. In embodiments employing one or more fans, such as in conjunction with a heat sink (e.g., fins), the one or more fans may be positioned outside of the rugged body (of the carrier module and/or system). In yet other embodiments, the active heat dissipation means comprises one or more heat pipes, comprising thermally conductive tubes (e.g., manufactured of copper, aluminum, stainless steel or the like) with vaporizable gas (e.g., water, ethanol, naphthalene or the like) therein. Heat pipes may be useful, in some embodiments, to inexpensively and rapidly transfer heat from a point of high concentration to another point of lower heat concentration. Notably, any one or more active and/or passive cooling mechanisms may be combined to provide cooling in some embodiments.

While FIGS. 1 to 8 generally describe physical and structural components of an exemplary multi-server edge computing system, in accordance with some embodiments, the following description generally relates to a network architecture that may characterise such systems and enable some of the various advantages provided by embodiments herein described. In the following, it will be understood that an architecture may generally comprise one or more architecture-interfacing components, thereby providing for, for instance, the coupling of commercial-grade embedded computing modules (e.g., modules at least partly, or fully, compliant with a commercial standard and operable to perform various tasks associated with modern commercial computing tasks) with rugged network architectures, such as a VPX or like computing architecture, as described above.

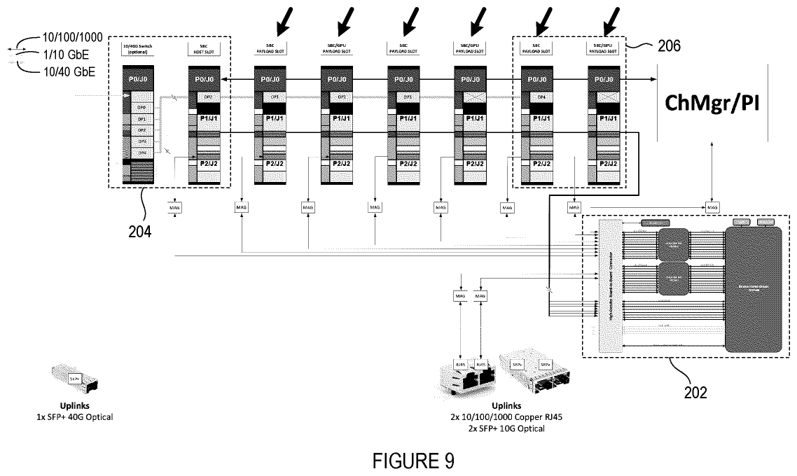

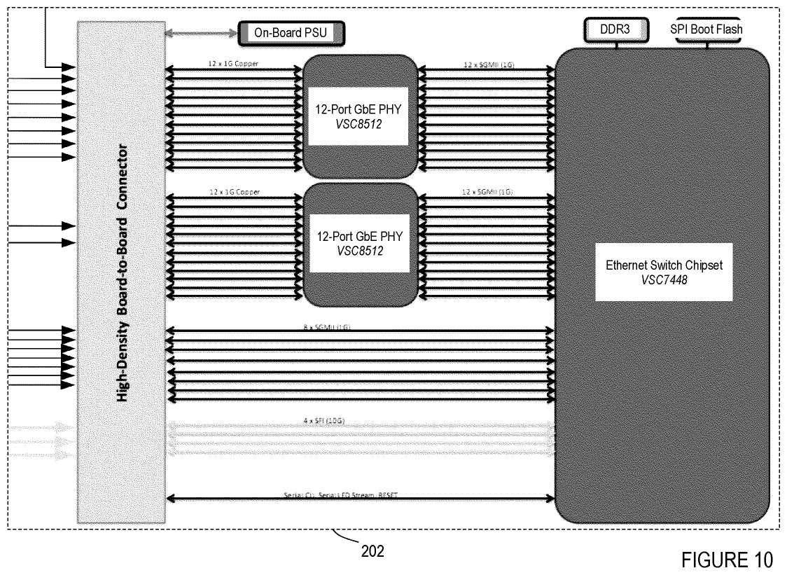

FIGS. 9 to 12 schematically illustrate one exemplary network architecture and connectivity. While FIG. 9 schematically illustrates an overview of the architecture and networking between modules, FIGS. 10, 11, and 12 schematically show zoomed in views of the regions 202, 204, and 206, respectively, of the architecture of FIG. 9. In this and subsequent examples, it will be appreciated that the network architecture comprises various schematic modules, with may correspond with various physical modules, such as switches, single-board computers, computer-on-module devices, and/or the like.

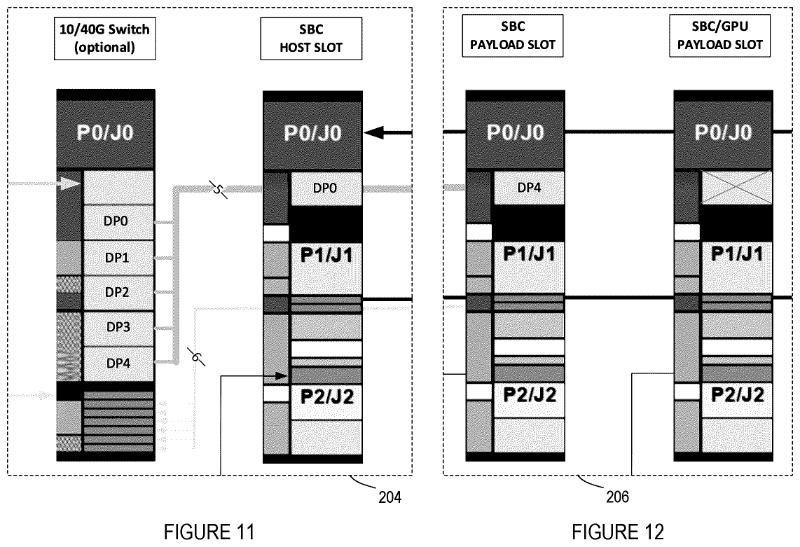

In accordance with some embodiments, some such modules may correspond to chipsets or the like that may be embedded within architecture-interfacing carrier modules and mounted within a computing architecture at least partly, or fully, compliant with a rugged computational standard and characterised by a compact form factor, such as those described above. For example, in the exemplary embodiment of FIG. 9, there is presented eight schematic modules in the upper portion of the schematic, seven of which correspond to payload slots such as those configured to receive an edge card in the embodiments described with reference to FIGS. 1 to 8. In this case, the seven rightmost schematic modules indicated by arrows correspond to such slots, wherein edge cards comprising respective computational modules may be interfaced within a rugged architecture. While four exemplary modules are shown in FIGS. 11 and 12, it will be appreciated that various embodiments relate to various combinations of module types, and are not limited to the specific modules and configurations schematically illustrated.

In accordance with one exemplary embodiment, the architecture comprises one or more 1G/10G switch mezzanines on the backplane, such as a Connect Tech Extreme™ 10 G and/or a MILTECH 9136™. Accordingly, there may be provided a network comprising 24× 1 GbE copper, 8× 1 GbE SGMII, and 4× 10G, in accordance with some embodiments. The 1 GbE copper ports may be used to connect to the 1000BASE-T connections on the payload slots, which may require magnetics coupling on the backplane. The 1 GbE SGMII ports may be used to connect to one of the two control ports on each payload slot for 1000BASE-KX support. The other control port is connected to a switch slot for 10GBASE-KR support. Only 6 of the 7 payload slots connect to the switch slot for 10GBASE-KR support. The switch slot also enables 10G/40G on the data plane. Only 5 of the 7 payload slots, in this exemplary embodiment, connect to the switch slot for 10G/40G data plane support. In the illustrated example, uplink ports are for reference only, and the actual quantity and physical interface corresponding thereto may vary depending on the particular embodiment. To provide one example of an alternative embodiment, the switch mezzanines (e.g., Connect Tech or Milpower embedded switch) may be mounted on the card carrier to create a switch-type carrier module, as opposed to backplane mounting.

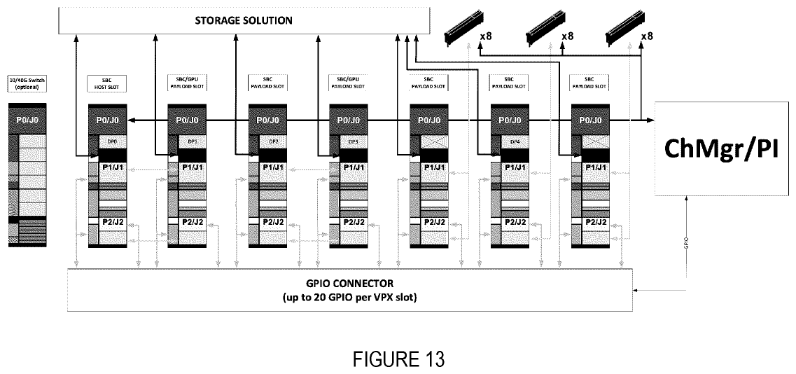

FIG. 13 schematically illustrates an alternative architecture corresponding with another embodiment. In this example, the architecture relates to a PCIe architecture providing a digital storage solution. In this case, a 4-lane expansion plane on each payload slot is reserved for the storage solution. This aspect may be particularly useful, in accordance with some embodiments, as it may offer a higher likelihood of PCIe support from a 3rd party single-board computer (SBC) that is thus readily accessible.

In accordance with different embodiments, PCIe expansion may be provided in different fashions via XMC pins on a profile at least partly, or fully, compliant with a rugged computational standard, in this case a VPX profile. For example, the pins may connect to an adjacent slot, which may be used to host a compatible 3U VPX expansion card, such as a GPU. In FIG. 13, this is illustrated between slots #2 and #3 and between slots #4 and #5. In some embodiments, the pins may connect to a standard x8 PCIe connector. In FIG. 3, this is illustrated on slots #6, #7, and #8.

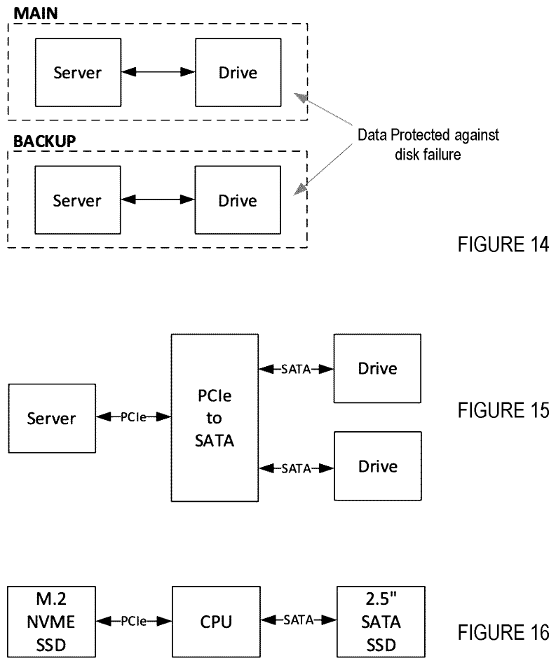

FIGS. 14 to 16 schematically illustrate aspects of three different non-limiting approaches to data storage, in accordance with different embodiments. Such examples schematically illustrate different approaches to data storage and backup that may be optionally employed, including redundant array of independent disks (RAID) approaches. In some embodiments herein considered, the use of solid-state drives (SSDs) may provide sufficient bandwidth, reliability, and server redundancy sufficient to employ a RAID-less design, optionally by mirroring data on different drives, for example using an M.2 NVME SSD and av2.5″ SATA.

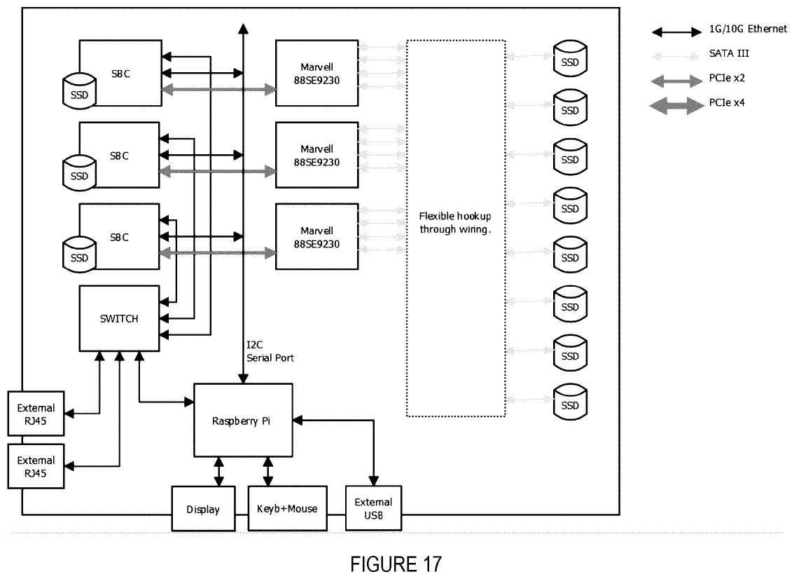

Various storage solutions are herein considered, wherein FIG. 17 schematically illustrates one exemplary variant. In the example of FIG. 17, which corresponds to an architecture similar to that of FIG. 3, but comprising a Marvell 88SE9230 chipset, and accordingly enables connectivity between 4 SATA drives, while supporting hardware RAID 0, 1, and 10. This further provides chipset form factors suitable for M.2, physical drive isolation between CPUs, hardware RAID 0/1/10, up to four drives per CPU, and ready scalability of the number of SBCs and SSDs without significantly contributing to PCIe complexity.

When employed within a system such as that of the multi-server edge system 100 described above, such architectures provide various abilities and advantages. For example, keyboard, video, and mouse (KVM) access may be provided to each payload slot (e.g. edge cards interfacing commercial-grade computing modules) to in turn provide for SBC initialisation and remote management.

For example, such aspects may be provided via KVM over ethernet using a customised SBC, or through an embedded KVM switch. While the former may provide for customised functionality and high performance, in accordance with some embodiments, the latter may provide a generic solution supporting third-part SBC modules (e.g., easily accessible) conformal with the target slot profile. In accordance with some embodiments, KVM over ethernet may be implemented using an ASPEED AST2500 or similar chipset, implemented on a custom rugged SBC (e.g., VPX SBC) provided with a PCIe link and USB port on the CPU to provide remote access over ethernet.

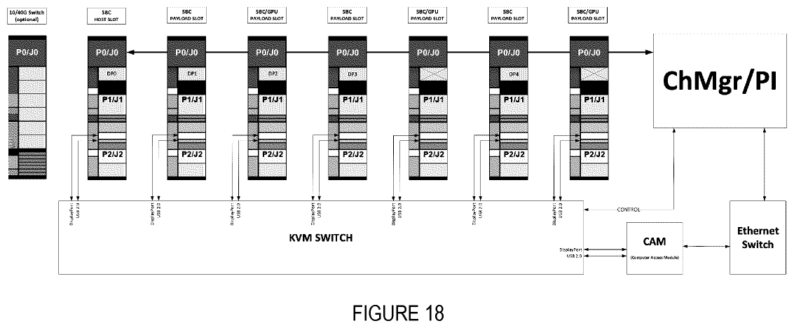

Conversely, in accordance with some embodiments, an embedded KVM switch may utilise a display port on a VPX profile for video, while utilising a USB port on the profile for a keyboard and mouse/trackpad. Such an embodiment is schematically shown in FIG. 18, and may provide connection between an embedded display, keyboard and mouse pad with each payload slot/edge card module. Such embodiments may further relate to a KVM over ethernet solution for providing remote access.

As described above, various embodiments relate to an architecture-interfacing carrier module configured to interface two, often fundamentally different, computing architectures. On one hand, commercial chipsets offer modern solutions to computational challenges, but often lack networking ability, robustness, and/or compatibility with small form factor computing architectures. Rugged architectures, such as VPX, VNX, short-VPX, and others noted above, on the other hand, are often defined by high robustness and networking functionality, and/or compact form factors. In order to bridge such often disparate platforms, various embodiments herein described seek to find and marry potential candidates of rugged architectures and high-performance computing modules for interfacing. In some embodiments, this relates to the selection of commercial embedded computing modules having desired computational resources, such as a high-end digital processor (e.g., a Xeon® processor), with an overall form factor that is compatible with that of a computing architecture standard providing a designated ruggedness and connectivity framework in a final device and/or system configuration. Embodiments thus provide for high performance edge computing suitable to modern applications within systems operable in (sometimes extreme) conditions experienced by the edge. Moreover, various such embodiments enable high performance computing within systems in accordance with unrivaled power consumption metrics, and spatial and environmental footprints. The following description relates to various examples suitable for such integration, as well as provides exemplary components and connectivity therebetween that provide for rugged edge computing systems, in accordance with various embodiments.

Notably, in the embodiments following, when the architecture-interfacing carrier module uses a compute module, such as COMe or the others described herein, this provides the ability to install a wide variety of COMe boards, spanning many types of CPU stock-keeping units (SKUs), thus reducing cost and time to market as well as providing users with a much wider range of options to choose from for testing and production use cases. As such, certain embodiments disclosed offer dozens of options with a single carrier design, such that the evolution of COMe boards, for example, can be accommodated by simply clicking them onto embodiments of the carrier module disclosed, perhaps with slight modification to the carrier module (being quick and/or cost-effective as compared to an entire redesign). Thus, in some embodiments, by converting VPX products which are traditionally not carrier-based for their CPUs into ones that are carrier-based, the architecture-interfacing carrier module (and/or the overall system) achieves several major competitive advantages.

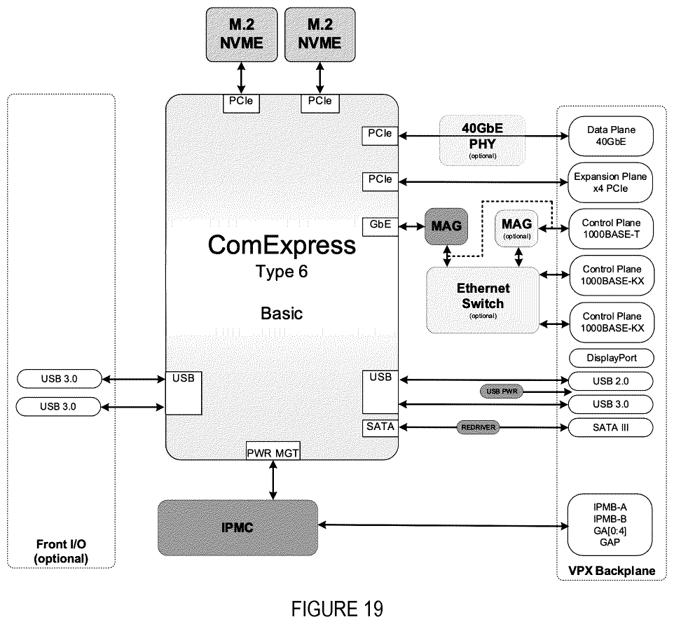

In accordance with three exemplary embodiments, FIGS. 19 to 21 are schematics illustrating exemplary components and connectivity of a commercial embedded computing module interfaced with a rugged computational architecture. As described above, such examples may relate to the employ of an architecture-interfacing carrier module, wherein various functionalities, inputs, and/or outputs of the commercial chipset are mapped to suitable interfaces or components of a rugged framework at least partly, or fully, compliant with a rugged computational standard more rugged and distinct from a commercial standard with which the commercial embedded module is compliant. Generally, such embodiments relate to the selection of a commercial module that may be structurally and/or electrically interfaced within a designated rugged framework defining accessible form factors or ruggedness requirements, or vice versa, and may thus relate to one or more of various commercial computing standards and/or module form factors, and one or more of various rugged computational standards and/or form factors. However, for exemplary purposes, only, the following examples relate to a rugged external architecture at least partly, or fully, compliant with a VPX standard, and in particular to a 3U VPX carrier standard, while commercial modules generally relate to the COMe commercial standard. Notably, whilst mention is made here of “selection”, it is to be appreciated that advanced, intricate and/or inventive adaptation, reconfiguring, redesign and/or the like may be required in some embodiments so as to make any such selection of the commercial and rugged computing standards operatively and/or spatially integratable.

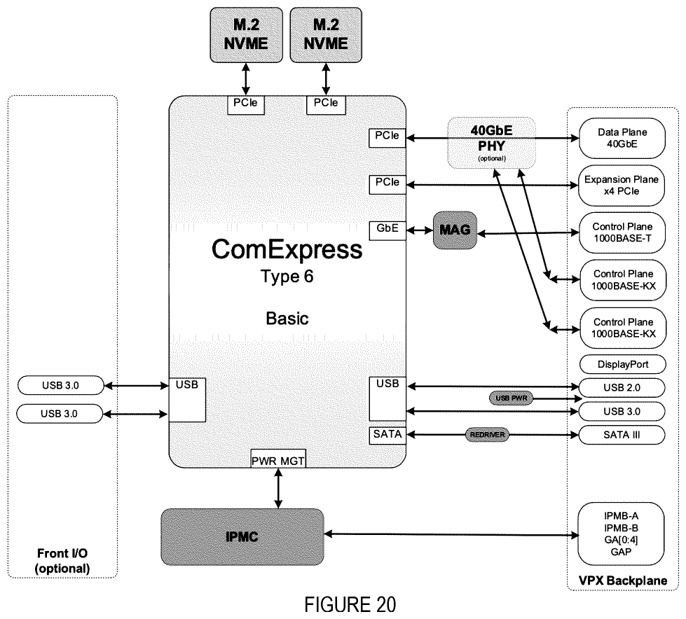

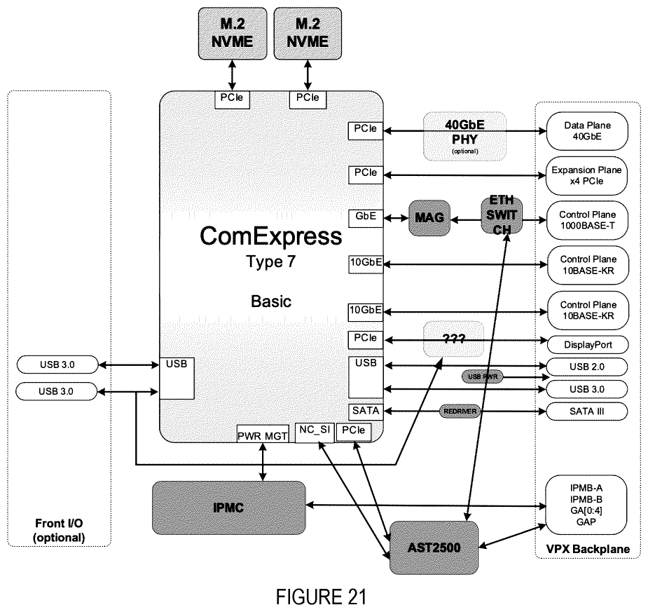

In accordance with a first exemplary embodiment, FIG. 19 schematically illustrates exemplary components and connectivity between a COMe Type 6 embedded computing module within a 3U VPX carrier framework. In this example, the Type 6 module form factor is suitable (e.g., does not exceed a maximum length, width, or height dimension, does not have a form factor specification that is too small, or the like) for integration within the internal dimensions of a carrier card at least partly, or fully, compliant with 3U integration standards. While FIG. 19 schematically illustrates exemplary connectivity within an architecture comprising an ethernet switch, FIG. 20 schematically illustrates another example comprising a Type 6 integration within an architecture comprising a 40 GbE PHY hardware network switch. FIG. 21, on the other hand, schematically illustrates a network architecture comprising a Type 7 COMe module, which, in accordance with some embodiments, may also be suitable for integration within a 3U framework.

It will be appreciated that while description herein with respect to commercial modules may relate to COMe Type 6 and Type 7 boards, other embodiments may relate to alternative or additional modules. For example, Type 6 and 7 modules, sometimes referred to as ‘Basic’ modules, may comprise a form factor of 95 mm×125 mm. Other embodiments, however, may relate to ‘Compact’ form factors, (e.g., 95 mm×95 mm) and ‘Mini’ form factors (e.g. 55 mm×84 mm). For example, some embodiments relate to the employ of Type modules. Such form factors may similarly be considered within the context of the various embodiments herein described, for example via integration of such mini or compact modules within architecture-interfacing modules configured to interface with a suitable rugged architecture.

Enablement of such integration, in accordance with some embodiments, is provided through selection of components and modules that are compatible, and in some embodiments, reconfiguration and/or redesign thereof. For instance, a 3U carrier module configured in accordance with various embodiments herein described for interfacing different architectures may be compatible to host COMe Type 6 and Type 7 modules that are compliant with COMe Revision 3.0, while COMe modules designed in accordance with to COMe Revision 1.0 may not be suitable for the same 3U module due to the fact some 12 V pins have been repurposed. This may be problematic if, for instance, the interfacing carrier module is not configured to have such pins protected.

Regarding form factor compatibility considerations, the COMe standard may, with relevance to some embodiments, be described with respect to a maximum component height. For example, the maximum component height on the top side of a module may define two stacking heights corresponding to 5 mm, which may allow for a component height of 1 mm on a carrier; and 8 mm, which may allow for a component height of 4 mm on the carrier. In accordance with some embodiments, a stacking height of 5 mm may be preferred for implementation on a 3U VPX-compliant carrier board. With respect to the bottom side of the board, the thickness of the PCB may be a consideration, which is typically 1.6 mm, and the bottom plate thickness of the module, which may, in some embodiments, relate to a minimum thickness for reliable operation (e.g., 1 mm thickness). Accordingly, the bottom component height may be calculated as 4.5 mm−1.6 mm−1 mm=1.9 mm.

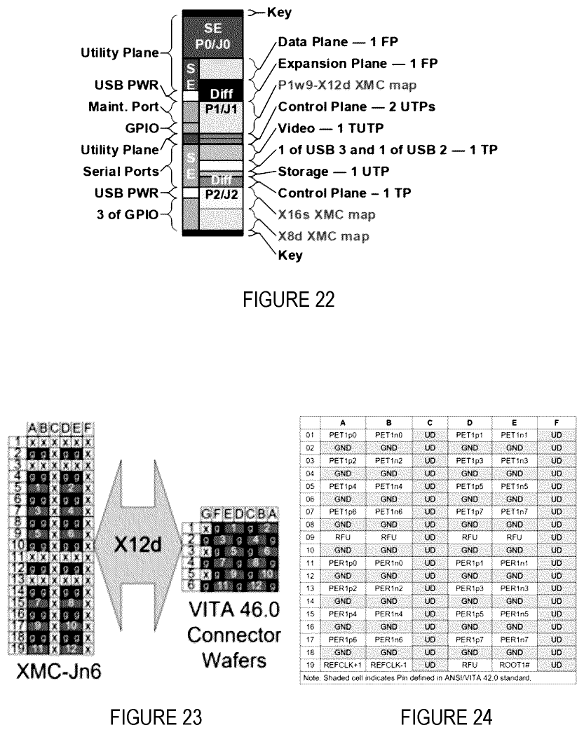

In accordance with some embodiments, a target profile for a rugged architecture may comprise the 3U I/O Intensive profile. This profile may be preferred for some embodiments, as it is referenced in the Technical Standard for SOSA Reference Architecture, Edition 1.0. This profile is further detailed in VITA 65.0 and VITA 65.1 under slot profile SLT3-PAY-1F1F2U1TUIT1UIT-14.2.16, and may serve as a preferred profile for some applications, and is schematically illustrated in FIG. 22, in accordance with some embodiments. Similarly, Table 1 provides various specifications comprising the definition of a VITA 65.1 profile.

TABLE 1
Module profiles defined in VITA 65.1; MOD3-PAY-
1F1F2U1TU1T1U1T-16.2.15-n, where n = 1 to 4

| Plane | Plane | −1 | −2 | −3 | −4 |
|---|---|---|---|---|---|
| Data Plane | DP01 (FP) | PCIe Gen 2 | PCIe Gen 3 | 10GBASE- | 40GBASE- |
| | | | | KX4 | KR4 |
| Expansion | EP00-EP03 | PCIe Gen 2 | PCIe Gen 3 | PCIe Gen 2 | PCIe Gen 3 |
| Plane | (FP) | | | | |
| Control Plane | Cputp01, | 1000BASE- | 10GBASE- | 1000BASE- | 10GBASE- |
| | Cputp02 | KX | KR | KX | KR |
| Control Plane | CPtp01 | 1000BASE-T | | | |
| Video | VID01 | DisplayPort 1.2 | | | |
| USB | USB01 | USB 2 | USB 3.1 | USB 2 | USB 3.1 |
| USB | USB02 | USB 2 | | | |
| Storage | STRutp01 | SATA Gen 2 | SATA Gen 3 | SATA Gen 2 | SATA Gen 3 |

| | | |
|---|---|---|
| Serial Ports | SER01 | Serial Ports |
| GPIO | GPIO1-GPIO4 | GPIO |

With respect to Table 1, various aspects may be of relevance for providing various of the embodiments herein described relating to COMe standard-compliant module integration. For example, the n=1 profile may be suitable for Type 6 and Type 7 COMe module integration; the n=2 profile may be suitable for Type 7 COMe module integration, which a Type 6 COMe module may not be suitable, as 10GBASE-KR is not natively supported on Type 6; and the n=3 and n=4 profiles may not be practical for some applications, as the 10GBASE-KX4 and 40GBASE-KR4 aspects operate over four lanes, which is not natively supported by COMe modules.

Generally, with respect to some VPX standards, XMC pins allow for a total of 28 differential pair connections, which, in accordance with various embodiments, are to be implemented in accordance with a VITA standard (e.g., VITA 46.9). Accordingly, various embodiments are at least partly, or fully, compliant with various permissions set forth in VITA documentation.

VITA standards (e.g., VITA 65.0) are typically specific with respect to the use of the XMC pins on a Slot Profile. For example, Rule 6.2.2-3 enforces that all pins assigned by a Slot Profile are used for that purpose or left unused. However, and in accordance with some embodiments, it is recognised that the physical presence of an XMC pin may be irrelevant for some applications, and that rather, compliance in function and protocol mapped to the XMC pins may be what is of relevance. Accordingly, the following description relates to the evaluation of a VITA standard (VITA 65.0) with respect to XMC pins. Further, it is recognised that such evaluation directly and indirectly refers to two additional standards, namely VITA 46.9 “PMC/XMC Rear I/O Fabric Signal Mapping on 3U and 6U VPX Modules Standard”, and VITA 42.3 “XMC PCI Express Protocol Layer Standard”, in accordance with this example.

FIGS. 23 and 24 schematically illustrate a pattern mapping between the X12d and XMC-Jn6 differential pairs on rows 5, 7, 9, 15, 17, and 19 to 6 of the 7-row differential wafers on a VITA 46.0 connector. For VITA 42.2 SRIO rear access ports, these pairs host the S1 4× serial link. For VITA 42.3 PCIe rear access ports, these pairs host PCIe lanes 4-7 plus+/−REF_CLK and Root1 #auxiliary signals. Further, from VITA 42.3 Table 4-3, signals on XMC-Jn6 are defined, which correspond to PCIe lanes 4-7. Even further, the following properties are observed with respect to the signals: 5 signals are reserved for future use, the REFCLK+/−100 MHz reference clock goes to the XMC, and the ROOT1 #may be driven low to enable Root Complex.

In accordance with some embodiments, similar mapping and inferences may be evaluated to determine properties that may be of value in the provision of rugged edge node server systems, including mappings of the X8d pattern to XMC-Jn6 differential pairs on rows 1, 3, 11, and 13 to 4 of the 7-row differential wafers on the VITA 46.0 connector, and the X16s pattern to the single-ended contacts on XMC-Jn6 rows 12-19 to 4 of the 7-row differential wafers on the VITA 46.0 connector.

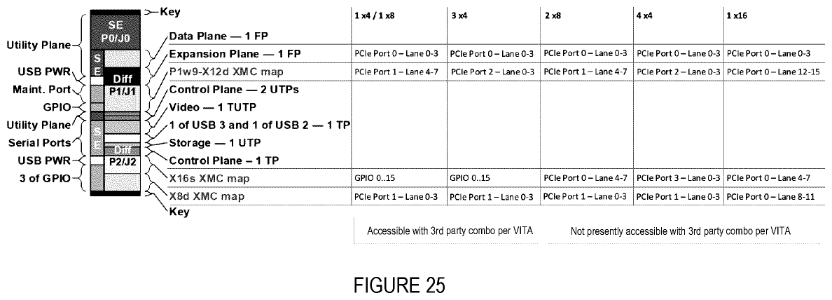

From such mappings, it has been concluded, in accordance with various embodiments, that, on a custom 3U VPX-COMe architecture-interfacing carrier module, the XMC pins (X12d & X8d) can be used to bring out an additional x8 PCIe link to the VPX backplane. Since the implementation follows VITA 65.0, VITA 46.9, and VITA 42.3, there may be 3rd party 3U VPX SBCs with XMC that provide the same functionality, and may be exploited for use in various systems. Similarly, on a custom 3U VPX-COMe architecture-interfacing carrier module, the XMC pins (X16s) can be used to bring out an additional 16 GPIO signals to the VPX backplane. Since the implementation follows VITA 65.0, VITA 46.9, and VITA 42.3 there may be 3rd party 3U VPX SBCs with XMC that provide the same functionality, and may be exploited for use in various embodiments. Similarly, it may be concluded that for some architectures, the use of XMC pins (X16s) for PCIe (additional 4 lanes) is not impossible, but may lack 3rd party 3U VPX SBCs with XMC that provide the same functionality, and thus may be less suitable for some applications. FIG. 25 summarises some such aspects, highlighting how various aspects of respective frameworks may be accommodated in various embodiments.

In accordance with various embodiments, COMe interfaces are analysed to determine various pins and/or configurations thereof that may be useful for integration within VPX frameworks. In addition to the identification of corresponding ports to produce conventional functionality in a VPX framework, such aspects may, in accordance with some embodiments, enable the provision of functionality and/or computational resources that are not conventionally available with VPX platforms. For instance, unnecessary, unused, and/or ports without a VPX analogue may be repurposed, directed, reconfigured and/or redesigned for various applications or functionality heretofore lacking in VPX-compliant systems.

More generally, however, the following description continues, in some aspects, to relate to how an architecture-interfacing carrier module may couple respective internal and external interfaces respectively configured to electrically interface with an external computing architecture at least partly, or fully, compliant with a rugged computational standard (VPX, in this case) and an embedded computing module having an interfacing module-compatible form factor and that is at least partly, or fully, compliant with a commercial computational standard (in this case, COMe) distinct from and less rugged than the rugged computational standard.

For example, high-definition audio (HAD) pins that are left unconnected may be identified and repurposed, while Gb ethernet interfaces may be connected to a VPX backplane (e.g., to the 10000BASE-T interface) via circuitry and interfaces of a carrier module. Conversely, ethernet status LED signals typically used to show activity and link status, signals which are unavailable within a VPX profile, may be repurposed through connective circuitry to, for instance, address LEDs on a rugged system, for instance as LEDs visible from the front of a board.

Similarly, a GBE0_SDP software-definable pin may be routed for IEEE1588 support as a 1pps signal. For maximum support, a carrier module may connect the GBE0_SDP pin (3.3V) to VPX AUX_CLK pins (LVDS) as an input or output, in accordance with some embodiments.

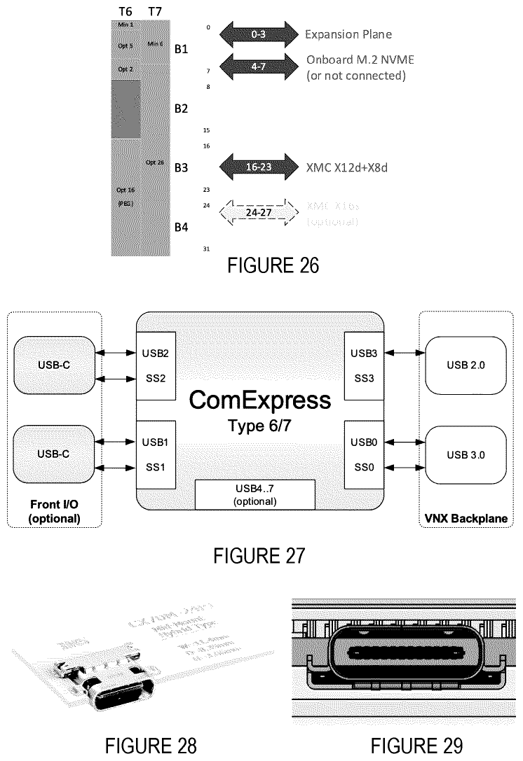

This notion may be expanded to include other COMe aspects that may be mapped, repurposed, redesigned, reconfigured or otherwise utilised in a rugged computing architecture. For example, Network Controller Sideband Interface (NC-SI), optionally available on Type 7 modules and comprising an electrical interface and protocol defined by the Distributed Management Task Force (DMTF) to enable the connection of a Baseboard Management Controller (BMC) to enable out-of-band remote manageability, may be mapped to a compatible interface of a rugged computational platform. Conversely, 10 Gb ethernet interfaces, comprising between 0 and 4 ports on Type 7 modules, may, in accordance with some embodiments, provide signals that may otherwise remain unconnected, and thus may connect to a VPX backplane for increased system functionality. Such aspects may, in accordance with some embodiments, be extended to SATA ports, SATA status LED, and PCIe lanes to further increase system performance, to name a few. For example, FIG. 26 schematically represents PCIe lanes that may be used for various applications within a VPX framework.

Another example of such VPX mapping includes the COMe reference clock output, which may be connected via module circuitry to a REF_CLK VPX input interface (optionally provided with buffering), in accordance with one embodiment. In some embodiments, an intelligent platform management controller (IPMC) can enable/disable the REF_CLK based on the GA pins.

With respect to USB ports on a COMe-compliant module, between 4 and 8 USB2.0 ports are available on Type 6 modules, while four USB2.0 ports are available on Type 7 modules. Both Type 6 and Type 7 modules may support USB 3.0 (SuperSpeed, SS) on up to 4 ports. While it may be important for some systems to use a COMe card with at least one SS port for full VPX profile compliance, some ports (e.g., ports 4 to 7) may be unused. FIG. 27 schematically illustrates how such USB ports on either Type 6 or Type 7 modules may be accessible within the context of VPX integration within an edge computing platform, in accordance with some embodiments. As an extension of this concept, and in accordance with some embodiments, FIGS. 28 and 29 represent superspeed USB ports that may be added to a front panel of a computing architecture. Such embodiments may be characterised, for instance, by a mid-mount USB-C connector such as a CX70M-24P1, which, when mounted on a bottom side, may have a height of less than 0.75 mm under a COMe module, which may remove potential for any mechanical conflicts. For instance, the bottom height of some such system components may be 1.35 mm, which would not cause issues with a bottom plate of a module, in accordance with some embodiments. In some embodiments, one or more front panel USB-C ports (or the like) may be employed as a power delivery port, as described elsewhere herein.

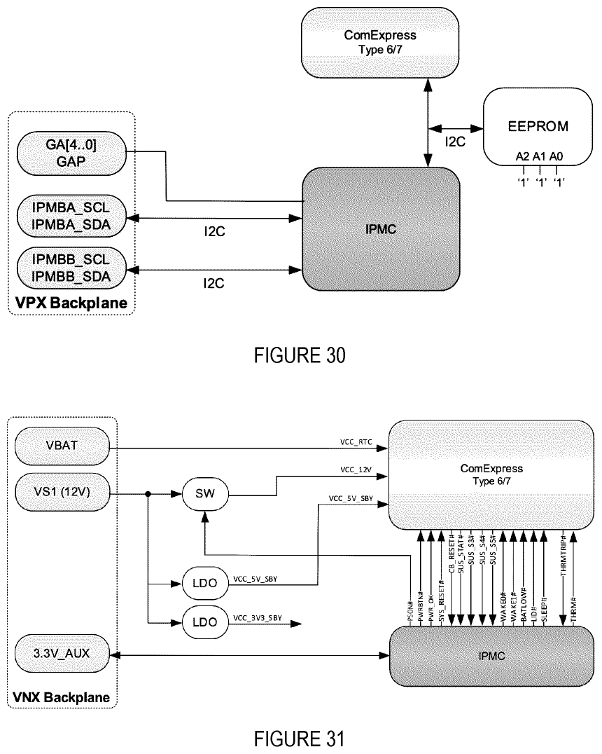

The evaluation of available COMe ports for integration within a VPX functionality may continue with the identification of corresponding and/or compatible ports corresponding to overcurrent signals, host functionality, LVDS flat panel/eDP embedded DisplayPort, Remote BIOS, LPC/eSPI interface, SPI, analog VGA, digital display interface (DDI), general-purpose serial interface/CAN bus, SM Bus, GPIO/DSIO, and I2C. For example, the I2C port of COMe is traditionally intended for an optional EEPROM on the module and/or carrier, and may support multi-master mode. A carrier module, in accordance with some embodiments, may comprise a I2C EEPROM (e.g. >2 Kbit) that is accessible from the COMe and the IPMC. FIG. 30 schematically illustrates how such an embodiment may be networked within the context of a VPX framework, in accordance with some embodiments.

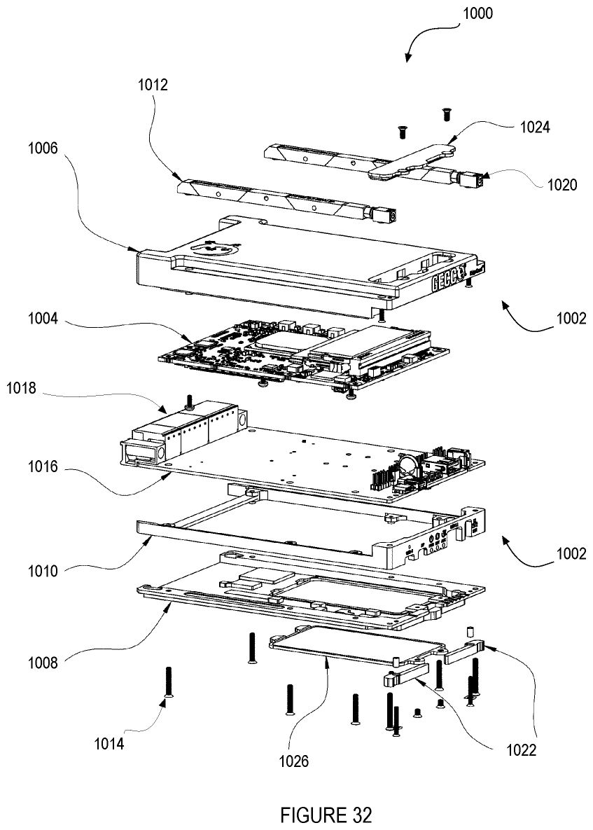

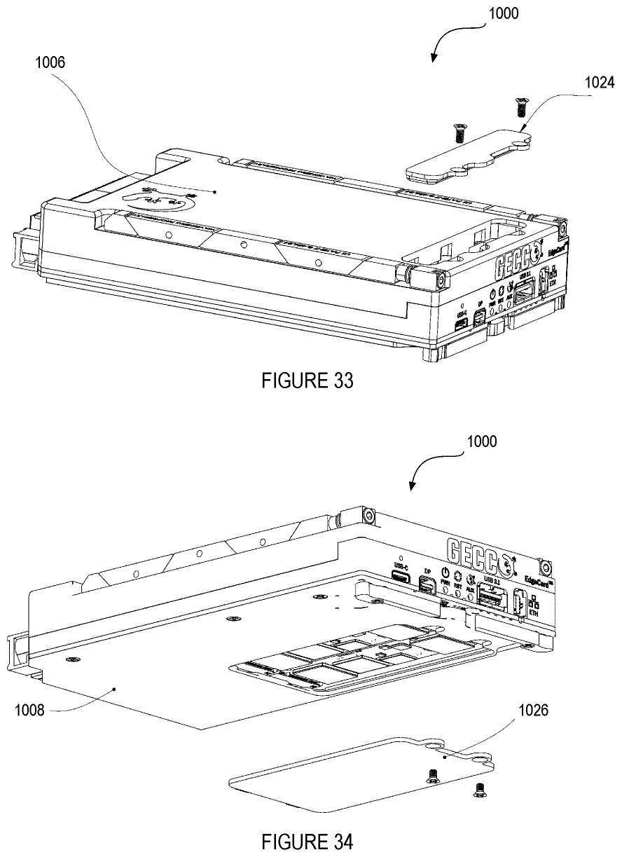

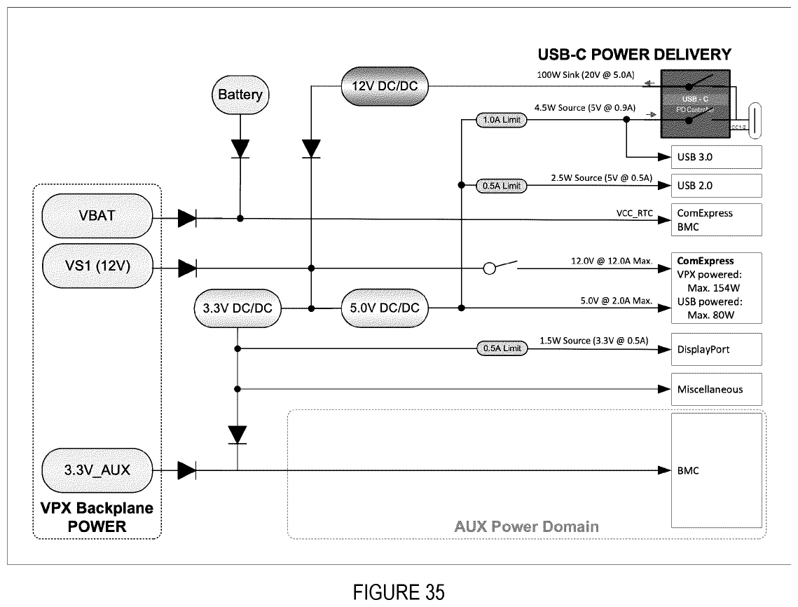

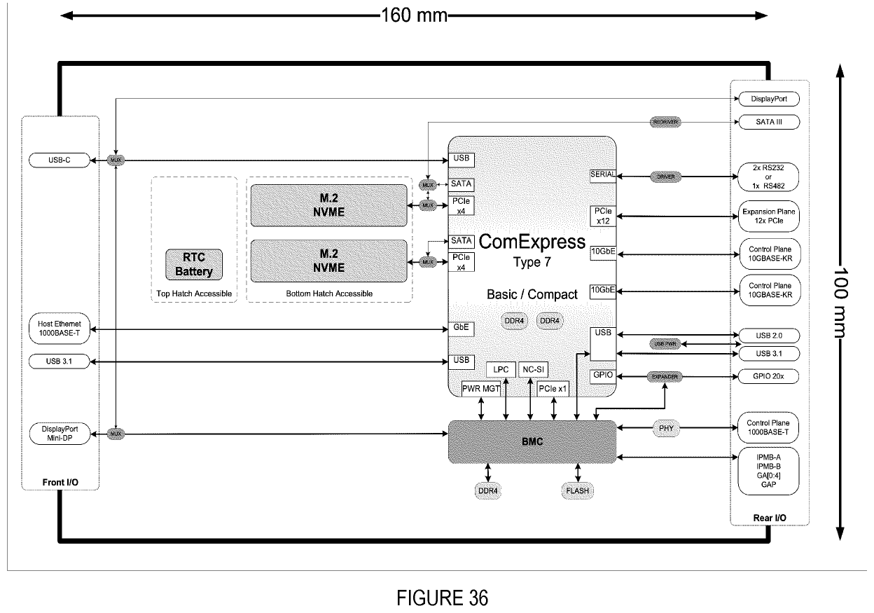

In accordance with some embodiments, power and system management signals of a computing architecture as herein described may connect to an intelligent platform management controller (IPMC), such that the IPMC is in control and at least partly, or fully, compliant with signals from a VPX backplane, and/or wherein custom logic can be implemented based on signals from the VPX backplane. FIG. 31 schematically illustrates one exemplary power and thermal management configuration, in accordance with some embodiments. It will be appreciated that, in accordance with some embodiments, power and system management, thermal protection parameters, and power and ground signals may be characterised, including respective pin types, power rail and tolerance, and/or pin availability, for integration within a hybrid COMe-VPX architecture.

In accordance with various embodiments, an IPMC may be integrated within a computing system. For instance, an IPMC may perform the following exemplary tasks: communication with a chassis manager over a backplane IPMB; VITA 46.11 compliancy; power up and reset logic; handling of VPX signals, GDiscrete, SYS_CON, and Maskable_Reset; enabling/disabling of VPX REF_CLK buffer; setting the direction of a VPX AUX_CLK buffer; and/pr handing GPIO; to name a few.

Various considerations may be of more or less relevance, depending on the application at hand. For example, communication with the chassis manager may be relatively straightforward to implement in a microcontroller. Accordingly, an FPGA may be employed, particularly in the case of an FPGA SoC. However, such devices may be expensive, and a STM32 microcontoller may be preferred. For instance, such a microcontroller may provide the following non-limiting benefits, such as low power, low cost (e.g., under $10), and/or small footprint. Further, there exist various reference designs, including OpenIPMC, which has targeted a STM32 microcontroller, and Commercial IP.

In accordance with some embodiments, an IPMC may be implemented in accordance with various standards. For example, an IPMC may be at least partly, or fully, compliant with a TCA standard, which may be modified for VITA compliance, in accordance with some embodiments.

Generally, the interfacing of commercial embedded computing modules within a rugged framework may provide a resultant rugged architecture having more advanced capabilities than a traditional rugged architecture, with a markedly greener footprint than conventional commercial systems. That is, through leveraging of the additional functionality of commercial modules via signal mapping to rugged architectures, various commercial functionalities are conveyed to the system that are otherwise unavailable in conventional frameworks, in accordance with some embodiments.

Turning now to FIGS. 32 to 34, there is provided in accordance with a further aspect of the disclosure, a digital architecture-interfacing carrier module 1000 (“carrier module device”, also referred to as an “edge card”) which is operable independent of a larger system. In particular, in this embodiment, the carrier module device 1000 is configured to provide a standalone computing device or unit, which is operable independent of a backplane or similar external computing architecture, and/or other computing devices or cards.

The carrier module device 1000 shown in FIGS. 32 to 34 shares similarities with that illustrated with reference to FIGS. 5 and 6. In particular, with reference to the exploded view shown in FIG. 32, the carrier module device 1000 comprises an exemplary ruggedised module body 1002, which is specifically configured in accordance with a VPX standard (e.g., 3U VPX), and comprises ruggedised outer surfaces and coupling structures. The carrier module device 1000 further comprises an exemplary commercial embedded computing module 1004 which is specifically configured in accordance with a commercial standard (e.g., COMe), and comprises certain commercial features, as elsewhere described. In this embodiment, the integration of the VPX and COMe standards in the carrier module device 1000 is provided with further features which are typically required or advantageous in commercial applications, although not limited thereto.

The ruggedised module body 1002 of the carrier module device 1000 is comprised of an upper frame member 1006 and a lower frame member 1008, separated by a frame body 1010. In this embodiment, the upper and lower frame members 1006, 1008 are manufactured of a conductive material so as to thermally conduct heat from the internal componentry of the body 1002. The ruggedised module body 1002 further comprises wedge locks 1012, and various fastening members 1014 (e.g., screws) by which the body 1002 is assembled into a compact form factor. In particular, in this embodiment, the carrier module device 1000 is characterised by a form factor of approximately 6″×4″×1″, which, as a standalone unit, or as part of a larger system, is markedly more compact than conventional devices. Notably, the wedge locks 1012 also facilitate the conduction of heat from module components to a surrounding environment (particularly when the body 1002 is received into a chassis 104, such as a VPX subrack, for example).

The carrier module device 1000 in this embodiment further comprises a rugged carrier card 1016 (e.g., a VPX carrier card), which interfaces with the commercial embedded computing module (e.g., COMe, specifically Com Express® Basic Type 6 or Type 7) 1004 with a rugged interface (e.g., a VPX interface). In order to secure the rugged carrier card 1016 within the carrier module device 1000, the frame body 1010 specifically comprises a VPX card chassis (e.g., 3U VPX) in this embodiment. The rugged carrier card 1016 further comprises a connector block 1018, arranged at a rear end of the carrier card 1016 within the frame body 1010 which comprises circuitry elements configured to interface with the commercial embedded computing module 1004. In some embodiments, as described below, the connector block 1018 further interfaces with an external computing architecture (e.g., VPX backplane), although this embodiment is notably capable of standalone operation. The connector block 1018 in this embodiment specifically comprises three similar VPX connectors placed side by side; however, other embodiments may remove one of these connectors to utilize that area for a different type of VPX connector (e.g., fibre optic, coaxial or the like) or otherwise a different commercial I/O connector, in different embodiments. In this embodiment, the rugged carrier card 1016 provides features including a board management controller (BMC) for remote management and monitoring, and keyboard, video, and mouse (KVM) access, amongst others.

The carrier module device 1000 in this embodiment further comprises insertion keys 1020 arranged on the end of the wedge locks 1012 for insertion of the body 1002 into a chassis or similar system structure or architecture, for some use cases. The carrier module device 1000 in this embodiment further comprises levers or latches 1022 arranged on a bottom, front end of the body 1002, which complement the insertion keys 1020 when the carrier module device 1000 is inserted into the chassis or similar system structure or architecture.

In the embodiment shown in FIG. 32, the end of the body 1002 shown on the right-hand side is considered the front end of the carrier module device 1000 (i.e., that being the end which, when the module 1000 interfaces with a backplane in some use cases, faces away therefrom). As shown in more detail in FIGS. 33 and 34, the front end (and specifically, the front panel) of the frame body 1010 in this embodiment includes several front-facing inputs and/or outputs, which are non-VPX connectors. In this particular embodiment, although it will be understood that other embodiments may comprise other combinations, without limitation, the front end of the frame body 1010 specifically comprises, from left to right in the front view, a USB-C connector, a display port, a power button, a reset button (RST), an auxiliary button (AUX), a USB 3.1 port and an ethernet port. Below this row of buttons and connectors, there is provided there is a small horizontal slot that functions as a memory card slot. Furthermore, further to the right, beneath the USB 3.1 port but above the righthand level, there are five small status LEDs which are programmable to display predefined indicators, as described elsewhere herein. In this embodiment, as will be described further below, the provision of a USB-C connector on the front end of the carrier module device 1000 allows for powering the entire carrier module device 1000 therethrough. In some embodiments, the same USB-C port may be used for a variety of data interfaces as well (i.e., concurrently). Notably, such front-facing inputs and/or outputs, in whatever number, combination or configuration, are features not traditionally or always included in conventional VPX SBCs in the defence industry. Instead, inputs and outputs are conventionally provided through the VPX backplane. As such, certain redesign and/or reconfiguration of the carrier card and associated logic was necessitated to incorporate same into the present embodiment, including from a spatial-and a logic conflict perspective (the latter potentially occurring when the carrier device module 1000 is interfaced with a VPX backplane or similar such that the module 1000 receives counter-part functions through the VPX connector from the rear end). The provision of the other inputs and outputs on the front end of the carrier device module 10000 allows it to operate in standalone mode, in some embodiments or use cases, apart from a VPX backplane or similar external computing architecture (and thus, apart from other cards or modules). In other embodiments, the front-facing non-VPX inputs and/or outputs, may include any one or combination of: ethernet, display port, USB-A (USB 3.1) ports, memory card slot, power/reset/aux buttons and assorted informational indicators (e.g., LEDs), real-time clock (RTC) and a battery.

In the embodiment shown, the end of the body 1002 shown on the left-hand side of FIG. 32 is considered the rear end of the carrier module device 1000. Although not shown in detail, the rear end of the body 1002 in this embodiment includes the connector block 1018 for connecting the carrier module device 1000 to the external computing architecture (e.g., VPX backplane), in some embodiments or use cases.

As further shown in FIG. 33, the upper frame member 1006 in this embodiment includes an upper hatch 1024, which is removable from the carrier module device 1000 without further disassembly via one or more fasteners (e.g., screws). In this particular embodiment, the upper hatch 1024 specifically provides access to the real time clock (RTC) battery, so as to allow for replacement, maintenance, upgrades, and/or the like. In this particular embodiment, the upper hatch 1024 further provides access to various pins, so as to allow for testing, troubleshooting, and/or the like.

As further shown in FIG. 34, the lower frame member 1008 in this embodiment includes a lower hatch 1026, which is removable from the carrier module device 1000 without further disassembly via one or more fasteners (e.g., screws). In this particular embodiment, the lower hatch 1026 specifically provides access to the underside of the carrier card 1016, as shown, and specifically to the two non-volatile memory express (NVME) solid-state drives (SSDs), so as to allow for installation, replacement, maintenance, upgrades, and/or the like. This brings us to a further aspect of the disclosure, which is the provision of two M.2 format PCIe connectors on the underside of the carrier card 1016, in this embodiment, which allows one or two external memory storage units (disk drives) of M.2 format to be installed on the card 1016. The provision of these storage slots or connectors, allowing for the connection of storage units, provides the carrier module device 1000 with its own internal storage. This internal storage therefore facilitates standalone operation of the carrier device module 1000, in certain embodiments. In this embodiment, the storage slots support M.2 based NVMe or SATA 3 memory unit formats, allowing up to 16Tb of storage, based on the current capacity of leading NVMe memory units (max of 8 TB each). It is to be appreciated that other embodiments may invoke and/or support other storage types, and/or storage amounts, without limitation. Indeed, it is envisaged that the certain embodiments may support memory units of larger sizes, such as 12Tb or 16Tb each. Notably, these storage units are, in this embodiment, cooled via conduction-based cooling, as described elsewhere herein.

Turning now to FIG. 35, and continuing the embodiment described with reference to FIGS. 32 to 34, this particular embodiment of the carrier module device 1000 provides for dual power delivery. More specifically, as mentioned above, the carrier module device 1000, operating as a standalone unit, is configured so as to receive power delivery from a front end power delivery port, specifically a non-VPX port, and in this embodiment, a USB-C port. The same carrier module device 1000, when operating as part of a larger system or architecture, and specifically interfacing with an external computing architecture (e.g., VPX backplane), is configured so as to receive power delivery from the external computing architecture (e.g., VPX backplane via the connector block 1018). As reflected in FIG. 35, the internal circuitry is configured, physically and logically, to accommodate such dual power delivery without power/current conflicts. Notably, here such dual power delivery is referring to in the alternative, that being, either power delivery from the front end via the front-end power delivery port (USB-C) or power delivery from the rear end via the external computing architecture (e.g., VPX backplane), at any stage in time. In other embodiments, such dual power delivery allows for concurrent power delivery, that being, power delivery from the front end via the front-end power delivery port (USB-C) and/or power delivery from the rear end via the external computing architecture (e.g., VPX backplane), concurrently, at any stage in time without conflict. Certain reconfiguration and/or redesign of the various componentry and internal logic of the carrier module device 1000 at least partly enables such dual power delivery in this embodiment. In particular, as shown in FIG. 35, the power delivery from the USB-C or VPX backplane (including battery voltage (VBAT), VS1 (12V) and/or 3.3V AUX) is fed into the same circuitry, stepped down in a similar manner (where applicable), to feed the same componentry of the device 1000, depending on whether or not front-end power is delivered to the device 1000. The componentry fed includes, without limitation, a USB 3.0, a USB 2.0, ComExpress BMC, ComExpress, Display Port, BMC and miscellaneous power draws. The embodiment shown in FIG. 35 further includes an additional battery which may, in some embodiments, power the device 1000 at least for a short period of time in the case of power delivery failure from the front or rear end ports. Notably, the provision of a front-end power delivery port (e.g., via a USB-C port in this non-limiting example) is at least one feature not contemplated in conventional VPX architectures and/or standards. Thus, to operate the carrier module device 1000 in standalone mode, a user would simply plug the carrier module device 1000 into an inexpensive USB-C wall adaptor, thereby to boot up the carrier module device 1000 (as a server, GPU, switch, or the like). Furthermore, in this embodiment where USB-C is implemented, it is to be appreciated that beyond front-end power delivery, the USB-C connector further allows two-way data feeds for a wide variety of other I/O types beyond the other I/O's on the front panel (described elsewhere). The use of USB-C is thus useful in some embodiments to allow for the addition of other I/Os, such as additional ethernet ports, memory cards, USB 2 & 3, HDMI, and the like. It is to be appreciated that the power circuitry shown in FIG. 35 is exemplary only and other embodiments may comprise variations and/or additions without detracting from the general nature of this aspect of the disclosure. Notably, such front-facing power delivery is a feature not included in conventional VPX SBCs in the defence or aerospace industry. Instead, conventional SBCs within VPX systems are powered solely through VPX connectors to a backplane. As such, certain redesign and/or reconfiguration of the carrier card and associated logic was necessitated to incorporate same into the present embodiment, as shown.

Turning now to FIG. 36, and continuing the embodiment described with reference to FIGS. 32 to 34 (although here a ComExpress Type 7 is utilized, as opposed to Type 6, although those skilled in the art will appreciate the similarities between Types 6 and 7, without limitation), this particular embodiment of the carrier module device 1000 provides for remote management of the carrier module device 1000 itself. In particular, in this embodiment, the carrier module device 1000 includes a baseboard management controller (BMC) to enable out-of-band remote manageability thereof. In this embodiment, the BMC is specifically provided on the rugged VPX carrier card 1016 and is specifically designed to fit and function thereon with limited space and power. As shown in FIG. 36, the BMC interfaces directly with the ComExpress commercial embedded computing module 1004. As such, the carrier module device 1000 in this embodiment is capable of remote management independent of the external computing architecture (e.g., VPX backplane) although, in some embodiments, the BMC is operable in conjunction therewith, as later described. In this embodiment, as shown, the carrier module device 1000, including both the front and rear facing inputs and outputs, has dimensions of 160 mm by 100 mm (consistent with VPX standards, other standards may have other dimensions, such as a short VPX standard having dimensions of 100 mm×100 mm). Although not shown, customized BMC firmware is employed to operate the BMC controller in this particular embodiment. It is to be appreciated that the BMC circuitry shown in FIG. 36 is exemplary only and other embodiments may comprise variations and/or additions without detracting from the general nature of this aspect of the disclosure. Notably, such remote management capability is a feature not included in conventional VPX SBCs in the defence or aerospace industry. As such, certain redesign and/or reconfiguration of the carrier card and associated logic was necessitated to incorporate same into the present embodiment, as described.

The carrier module device 1000 in this embodiment is, similar to embodiments described before, cooled via conduction-based cooling so as to maintain an acceptable or nominal operating temperature. Indeed, the addition of various features to the carrier module device 1000 which are not present in conventional VPX servers, as described herein, requires additional power flow, in turn generating additional heat within the fixed volume.

In this embodiment, to further facilitate dual operation, that is, the carrier module device 1000 being operable as a standalone unit and in conjunction with the VPX backplane, the carrier module device 1000 is configured to be hot pluggable. In particular, the carrier module device 1000 can be added to, or removed from, an energized VPX backplane without causing electrical damage to the carrier module device 1000 (or indeed, the VPX backplane) and/or without causing corruption to the operating system on the carrier module device 1000. In other embodiments, where the carrier module device 1000 is not hot pluggable, the addition or removal of the carrier module device 1000 from the VPX backplane may require deenergizing same to avoid such implications. Such other embodiments specifically provide a front-end power button, as described elsewhere herein, to allow a user to easily power down the carrier module device 1000 prior to removal. Again, such front-end power buttons (i.e., input feature) are not typically found on conventional VPX cards which are powered down remotely via IPMI. Notwithstanding same, alternative power control mechanisms may be employed in other embodiments of the carrier module device 1000, including remote powering down via IPMI or via the BMC of the carrier module device 1000.

Thus, in this embodiment, the carrier module device 1000 provides a standalone unit which integrates VPX and commercial standards, specifically COMe, having its own power delivery and remote management capabilities, amongst other features noted (e.g., front end inputs and outputs, M.2 or DDR4 SO-DIMM storage slots, hot pluggable, module cooling, and/or the like). As such, the carrier module device 1000 in this embodiment may be considered a VPX SBC which is specifically operable without a VPX backplane (unlike conventional VPX SBCs known in the art). Indeed, operation of the carrier module device 1000 in standalone mode provides, in some embodiments, a similar experience to conventional commercial servers at 90% smaller size and materials footprint. As such, the carrier module device 1000 may be particularly useful in installation environments with restricted space, typically too small to host full backplane-based VPX server systems.

The provision of a standalone carrier module device 1000, in some embodiments, may be beneficial so as to provide a cost-effective testing device. For example, the carrier module device 1000 may be employed in early-stage laboratory settings (educational or research and development), to test or develop the computing architecture, thereby reducing the upfront need to purchase comprehensive systems (and/or multiple modules) at high costs. Indeed, with conventional technologies, a variety of bulky and expensive equipment was needed to setup a VPX-based research and development (R&D) computing environment, often in the $50,000 plus range, not including the cost of each VPX SBC (usually $12,000 to $20,000 each). In contrast, the replacement of such complex VPX-based R&D computing environments with the carrier module device 1000 disclosed herein may reduce costs to the order of $2500 to $5000 (with the optional of incrementally expanding thereon by the addition of further carrier module devices 1000), to provide one non-limiting example of cost reduction. Of course, as described in detail elsewhere, the carrier module device 1000 also greatly reduces the physical footprint required for the computing environment, as well as the eco-footprint of the R&D system.

Further, as described above, the standalone carrier module device 1000 which integrates commercial processing units within rugged architectures, when optimised to reduce power consumption while maintaining high computing standards, allows a completely functional server (i.e., including all powering, cooling, computation, storage, and the like) to consume between approximately 50 W and approximately 75 W during operation, as marked power consumption improvement over conventional servers.

Notwithstanding that the carrier module device 1000 is configured for standalone operation, it is further configured for operation in conjunction with a larger, external computing architecture, specifically a VPX backplane, in this embodiment. Such dual operation may be advantageous where, for example, the carrier module device 1000 is first tested individually before the larger system (e.g., edge computing system comprising the body, chassis and further carrier modules) is purchased and/or employed. In this embodiment, in order to achieve dual configuration, certain redesign and/or reconfiguration of the carrier module device 1000 is implemented. For example, to accommodate inputs/outputs on both the front-end of the carrier module device 1000 and through the rear end VPX connector from the VPX backplane (including for power delivery), internal logic is configured to avoid conflicts. Similar resign and/or reconfiguration for other componentry will be understood from the description and figures provided herewith.

The carrier module device 1000 described above is specifically described as a server. Nonetheless, it is to be appreciated that the same inventive concept(s) are envisioned to be equally or adaptively applicable to a switch, a graphics processing unit (GPU, or general-purpose graphics processing unit (GPGPU)), a data processing unit (DPU) or other card.

Whilst various embodiments are described with reference to the integration of VPX and COMe standards, it is to be appreciated that various other integrations are intended to fall within the general scope and nature of the present disclosure. To provide one non-limiting example, some embodiments are envisaged wherein a short VPX standard is integrated with a COMe Mini standard, without limitation. Indeed, various embodiments are envisaged whereby VPX becomes viable as a compute architecture for the commercial computing space. More specifically, as noted, some embodiments employ aspects of VPX to ruggedize commercial off-the-shelf computer-on-module technology to reduce cost by up to 80%, thus rendering VPX economically viable for commercial edge computing.

The devices, systems and methods disclosed herein may generally find application in more commercial-type settings or more general-purpose type computing settings, such as in manufacturing, warehouse (e.g., inventory systems), distribution or retail environments, to provide a few non-limiting examples. Other applications may include in business environments, such as in payroll systems or other employee management systems. Indeed, certain embodiments are aimed at providing, for commercial edge computing environments, at least an improved solution which is rugged whilst still having low Size, Weight, Power & Cooling (SWaP/C), although most embodiments are, as mentioned, marked advanced by these metrics. Notwithstanding same, the same devices, systems and methods may find application in military, defence and/or aerospace settings, particularly where more commercial-type features may be advantageous and/or necessary in the cross-section of defence and general-purpose computing use cases.

Whilst the embodiments described herein are often described with reference to a system, or system architecture, the same inventive concept(s) may be equally and/or adaptively applicable or workable in related devices or methods, without departing from the general scope and nature of the present disclosure.

While the present disclosure describes various embodiments for illustrative purposes, such description is not intended to be limited to such embodiments. On the contrary, the applicant's teachings described and illustrated herein encompass various alternatives, modifications, and/or equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A computing carrier module, comprising:
a ruggedised body comprising circuitry electrically coupling an internal interface and an external interface;
said external interface configured to electrically interface with an external computing architecture at least partly compliant with a rugged computational standard corresponding at least in part to a designated form factor and electrical component characteristics;
said internal interface configured to structurally and electrically interface with a commercial grade embedded computing module; and
a commercial grade embedded computing module interfacing with said internal interface and characterised by a form factor at least partly compliant with a commercial computational standard distinct from, and less rugged than, said rugged computational standard.

2. The computing carrier module of claim 1, wherein said commercial computational standard comprises a Computer-on-Module express (COMe) standard and wherein said rugged computational standard comprises a Virtual Path Cross-Connect (VPX) standard.

3. The computing module of claim 1, operable as a standalone unit which comprises a server, a graphics processing unit (GPU) or a switch.

4. (canceled)

5. The computing carrier module of claim 1, wherein said ruggedised body defines on a front end a power delivery connector for receiving external power to the computing carrier module, said power delivery connector being optionally in the form of a USB-C port.

6. (canceled)

7. The computing carrier module of claim 1, further comprising a remote monitoring controller.

8. (canceled)

9. The computing carrier module of claim 1, wherein said external interface is hot pluggable with said external computing architecture.

10. The computing carrier module of claim 1, wherein an external surface thereof is configured to thermally interface with a thermal dissipation device.

11. (canceled)

12. (canceled)

13. (canceled)

14. (canceled)

15. The computing carrier module of claim 1, wherein said rugged computational standard comprises one or more of a VPX standard, a short-VPX standard, an OpenVPX standard, a SpaceVPX standard, a VNX standard, a VITA standard, or a Sensor Open Systems Architecture (SOSA) standard; and wherein said commercial computational standard comprises one or more of a Computer-on-Module express (COMe) standard, a Qseven standard, a Smart Mobility Architecture (SMARC) standard or a PC104 standard.

16. (canceled)

17. The computing carrier module of claim 1, comprising circuitry configured to manage conflicts between inputs and/or outputs from front-end non-rugged connectors and rear-end rugged connectors.

18. A rugged and compact energy-efficient edge computing system comprising:
a compact body ruggedised for compliance with a rugged computational standard corresponding at least in part to a designated form factor with associated electrical component and interface characteristics;
a chassis securely mounted in said compact body and configured in accordance with said rugged computational standard to securely retain a plurality of architecture-interfacing carrier modules removably received therein to form said computing system; and
an architecture-interfacing carrier module comprising a ruggedised module body and circuitry electrically coupling respective internal and external interfaces respectively configured to structurally and electrically interface with:
an external computing architecture comprising said chassis and at least partly compliant with said rugged computational standard; and
an embedded computing module characterised by a form factor permitting structural interfacing with said architecture-interfacing carrier module and at least partly compliant with a commercial computational standard distinct from and less rugged than said rugged computational standard.

19. (canceled)

20. (canceled)

21. (canceled)

22. (canceled)

23. (canceled)

24. The system of claim 18, wherein said chassis is configured to retain said plurality of architecture-interfacing carrier modules in accordance with a spatial distribution characterised by an intermodular spacing permitting passive heat dissipation in accordance with a designated operational tolerance.

25. (canceled)

26. The system of claim 18, further comprising a thermal dissipation device, and wherein an external surface of said architecture-interfacing carrier module is configured to thermally interface with said thermal dissipation device.

27. The system of claim 26, wherein said thermal dissipation device comprises a tubular structure configured to flow a liquid coolant therethrough to thereby dissipate heat from said architecture-interfacing carrier module in thermal contact therewith.

28. (canceled)

29. The system of claim 18, further comprising a backplane circuitry module disposed in said compact body and electrically interfacing one or more of said plurality of architecture-interfacing carrier modules in accordance with said rugged computational standard; said backplane circuitry module being further configured to electrically interface with one or more external digital ports.

30. (canceled)

31. (canceled)

32. (canceled)

33. The system of claim 18, further comprising anyone or combination of: a display screen operatively coupled to said architecture-interfacing carrier module; user input device operatively coupled to said architecture-interfacing carrier module; a digital authentication device operable to unlock said compact body upon digital verification of an authenticated user; an exterior digital camera disposed on an external surface of said compact body; and an interior digital camera disposed on an inner surface of said compact body.

34. (canceled)

35. (canceled)

36. (canceled)

37. (canceled)

38. (canceled)

39. (canceled)

40. (canceled)

41. (canceled)

42. The system of claim 18, further comprising a Computer-on-Module device disposed within said ruggedised module body and configured to interface said architecture-interfacing carrier module with an external digital device.

43. (canceled)

44. (canceled)

45. (canceled)

46. The system of claim 18, wherein said commercial computational standard comprises a Computer-on-Module express (COMe) standard and wherein said rugged computational standard comprises a Virtual Path Cross-Connect (VPX) standard.

47. (canceled)

48. (canceled)

49. (canceled)

50. The system of claim 18, wherein said ruggedised module body defines on a front end a power delivery connector for receiving external power to said architecture-interfacing carrier module.

51. (canceled)

52. (canceled)

53. (canceled)

54. The system of claim 18, wherein said architecture-interfacing carrier module is hot pluggable with said external computing architecture via said external interface.

55. (canceled)

56. (canceled)

57. (canceled)

58. (canceled)

59. (canceled)

60. (canceled)

61. (canceled)

62. The digital architecture-interfacing carrier module of claim 1, wherein said external interface comprises a digital port configured to concurrently communicate a plurality of distinct electrical signals at least in part to said internal interface.

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. A carrier board at least partly compliant with a Virtual Path Cross-Connect (VPX) standard modified to receive thereon an embedded computing module at least partly compliant with a Computer-on-Module express (COMe) standard.

78. (canceled)

79. (canceled)
